(19) United States
(12) Patent Application Publication
(10) Pub. No.: US 2024/0072440 A1
(43) Pub. Date: Feb. 29, 2024

(54) ANTENNA ASSEMBLY AND ELECTRONIC DEVICE

(71) Applicant: GUANGDONG OPPO MOBILE TELECOMMUNICATIONS CORP., LTD., Dongguan (CN)

(72) Inventor: Xiaopu WU, Dongguan (CN)

(21) Appl. No.: 18/505,723

(22) Filed: Nov. 9, 2023

Related U.S. Application Data
(63) Continuation of application No. PCT/CN2022/082929, filed on Mar. 25, 2022.

(30) Foreign Application Priority Data
May 12, 2021 (CN) 202110515123.9

(51) Int. Cl. H01Q 5/364; H01Q 1/24

(52) U.S. Cl. CPC H01Q 5/364; H01Q 1/243

(57) ABSTRACT

An antenna assembly includes a radiator and a signal source. The radiator includes a first sub-radiator and a second sub-radiator. A coupling gap is defined between the first sub-radiator and the second sub-radiator. The first sub-radiator includes a first coupling end and a first free end. The first sub-radiator further includes a feed point and a first ground point. The feed point is positioned between the first free end and the first coupling end. A distance between the first ground point and the first coupling end is greater than a distance between the feed point and the first coupling end. The second sub-radiator includes a second coupling end, a second free end, and a second ground point positioned between the second coupling end and the second free end.

### CROSS-REFERENCE TO RELATED APPLICATION(S)

The application is a continuation of International Application No. PCT/CN2022/082929, filed Mar. 25, 2022, which claims priority to Chinese Patent Application No. 202110515123.9, filed May 12, 2021, the entire disclosures of which are incorporated herein by reference.

### TECHNICAL FIELD

The disclosure relates to the field of communications technologies, and in particular, to an antenna assembly and an electronic device.

### BACKGROUND

With the development of communication technologies, electronic devices having communication functions are becoming more and more popular, and imposing higher requirements on the network access speed. Therefore, how to improve a date transmission rate and a communication quality of the electronic device becomes a technical problem to be solved.

### SUMMARY

In a first aspect, an antenna assembly is provided. The antenna assembly includes a radiator and a signal source. The radiator includes a first sub-radiator and a second sub-radiator. A coupling gap is defined between the first sub-radiator and the second sub-radiator. The first sub-radiator includes a first coupling end and a first free end. The first sub-radiator further includes a feed point and a first ground point. The feed point is positioned between the first free end and the first coupling end. A distance between the first ground point and the first coupling end is greater than a distance between the feed point and the first coupling end. The second sub-radiator includes a second coupling end, a second free end, and a second ground point positioned between the second coupling end and the second free end. The coupling gap is between the second coupling end and the first coupling end, and both the first ground point and the second ground point are configured to be electrically connected to a reference ground. The signal source is electrically coupled to the feed point.

In a second aspect, an electronic device is provided. The electronic device includes a housing, a reference ground, and at least one antenna assembly provided in the first aspect. The reference ground is positioned in the housing. A radiator of the at least one antenna assembly is integrated into the housing, or is disposed on a surface of the housing, or is disposed in a space defined by the housing. The first ground point and the second ground point are both electrically connected to the reference ground.

### BRIEF DESCRIPTION OF THE DRAWINGS

To describe technical solutions in embodiments of the disclosure more clearly, the following briefly introduces the accompanying drawings required for describing the embodiments. Apparently, the accompanying drawings in the following description only illustrate some embodiments of the disclosure. Those of ordinary skill in the art may also obtain other drawings based on these accompanying drawings without creative efforts.

FIG. 1 is a schematic structural view of an electronic device provided in an embodiment of the disclosure.

FIG. 2 is a schematic exploded structural view of the electronic device in FIG. 1.

FIG. 3 is a schematic structural view of an antenna assembly of the electronic device in FIG. 2 according to an embodiment.

FIG. 4 is a schematic structural view of an antenna assembly of the electronic device in FIG. 2 according to another embodiment.

FIG. 5 illustrates a graph of S-parameters of the antenna assembly in FIG. 3.

FIG. 6 illustrates a graph of S-parameters of the antenna assembly in FIG. 4.

FIG. 7 is a schematic structural diagram of a first matching circuit provided in an embodiment of the disclosure.

FIG. 8 is a schematic structural diagram of a first matching circuit provided in an embodiment of the disclosure.

FIG. 9 is a schematic structural diagram of a first matching circuit provided in an embodiment of the disclosure.

FIG. 10 is a schematic structural diagram of a first matching circuit provided in an embodiment of the disclosure.

FIG. 11 is a schematic structural diagram of a first matching circuit provided in an embodiment of the disclosure.

FIG. 12 is a schematic structural diagram of a first matching circuit provided in an embodiment of the disclosure.

FIG. 13 is a schematic structural diagram of a first matching circuit provided in an embodiment of the disclosure.

FIG. 14 is a schematic structural diagram of a first matching circuit provided in an embodiment of the disclosure.

FIG. 15 illustrates distribution of a first resonant current of the antenna assembly in FIG. 3.

FIG. 16 illustrates distribution of a second resonant current of the antenna assembly in FIG. 3.

FIG. 17 illustrates distribution of a third resonant current of the antenna assembly in FIG. 3.

FIG. 18 illustrates a graph of radiation efficiency of the antenna assembly in FIG. 4.

FIG. 19 illustrates distribution of a fourth resonant current of the antenna assembly in FIG. 4.

FIG. 20 illustrates distribution of a fifth resonant current of the antenna assembly in FIG. 4.

FIG. 21 illustrates distribution of a sixth resonant current of the antenna assembly in FIG. 4.

FIG. 22 illustrates distribution of a seventh resonant current of the antenna assembly in FIG. 4.

FIG. 23 is a schematic structural diagram illustrating a first sub-circuit of a first matching circuit of the antenna assembly in FIG. 4.

FIG. 24 is a schematic structural diagram illustrating a second matching circuit of the antenna assembly in FIG. 4.

FIG. 25 is a schematic structural diagram illustrating a third matching circuit of the antenna assembly in FIG. 4.

FIG. 26 is a schematic structural diagram illustrating a fourth matching circuit of the antenna assembly in FIG. 4.

FIG. 27 is a schematic structural diagram illustrating a third antenna assembly of the electronic device in FIG. 2.

FIG. 28 is a schematic structural diagram illustrating a first connection of a direct current block (DC-block) assembly, a filter assembly, and a detection assembly of the antenna assembly in FIG. 4.

FIG. 29 is a schematic structural diagram illustrating a second connection of the DC-block assembly, the filter assembly, and the detection assembly of the antenna assembly in FIG. 4.

FIG. 30 is a schematic structural diagram illustrating a third connection of the DC-block assembly, the filter assembly, and the detection assembly of the antenna assembly in FIG. 4.

FIG. 31 is a schematic structural diagram illustrating a first arrangement of a middle frame, a reference ground, and the antenna assembly in FIG. 4.

FIG. 32 is a schematic structural diagram illustrating a second arrangement of the middle frame, the reference ground, and the antenna assembly in FIG. 4.

FIG. 33 is a schematic structural diagram illustrating a third arrangement of the middle frame, the reference ground, and the antenna assembly in FIG. 4.

FIG. 34 is a schematic structural diagram illustrating a first antenna assembly, a second antenna assembly, a middle frame, and a reference ground provided in embodiments of the disclosure.

FIG. 35 is a schematic structural diagram illustrating a middle frame, a reference ground, and four antenna assemblies in FIG. 4.

### DETAILED DESCRIPTION

An antenna assembly and an electronic device are provided for improving a data transmission rate and communication quality.

In a first aspect, an antenna assembly is provided in the disclosure. The antenna assembly includes a radiator and a signal source. The radiator includes a first sub-radiator and a second sub-radiator. A coupling gap is defined between the first sub-radiator and the second sub-radiator. The first sub-radiator includes a first coupling end and a first free end. The first sub-radiator further includes a feed point and a first ground point. The feed point is positioned between the first free end and the first coupling end. A distance between the first ground point and the first coupling end is greater than a distance between the feed point and the first coupling end. The second sub-radiator includes a second coupling end, a second free end, and a second ground point positioned between the second coupling end and the second free end. The coupling gap is between the second coupling end and the first coupling end, and both the first ground point and the second ground point are configured to be electrically connected to a reference ground. The signal source is electrically coupled to the feed point.

In some embodiments of the disclosure, the radiator is configured to support at least three resonant modes under excitation of the signal source.

In some embodiments of the disclosure, the first ground point is positioned at the first free end.

In some embodiments of the disclosure, the radiator is configured to support a first resonant mode, a second resonant mode, and a third resonant mode under excitation of the signal source.

In some embodiments of the disclosure, a first resonant current in the first resonant mode is at least distributed between the first ground point and the first coupling end and between the second coupling end and the second ground point. A direction in which the first resonant current flows between the first ground point and the first coupling end is the same as a direction in which the first resonant current flows between the second coupling end and the second ground point. A second resonant current in the second resonant mode is distributed between the first ground point and the first coupling end and between the second coupling end and the second free end. A direction in which the second resonant current flows between the first ground point and the first coupling end is opposite to a direction in which the second resonant current flows between the second coupling end and the second ground point, and a direction in which the second resonant current flows between the second ground point and the second free end is opposite to a direction in which the second resonant current flows between the second coupling end and the second ground point. A third resonant current in the third resonant mode is distributed between the first ground point and the first coupling end and between the second coupling end and the second free end, where a direction in which the third resonant current flows between the first ground point and the first coupling end is opposite to a direction in which the third resonant current flows between the second coupling end and the second ground point, and a direction in which the third resonant current flows between the second ground point and the second free end is the same as a direction in which the third resonant current flows between the second coupling end and the second ground point.

In some embodiments of the disclosure, the first resonant mode is a (⅛˜¼) wavelength mode in which the first sub-radiator operates, the second resonant mode is a (⅛˜¼) wavelength mode in which part of the second sub-radiator between the second coupling end and the second ground point operates, and the third resonant mode is a ½ wavelength mode in which the second sub-radiator operates.

In some embodiments of the disclosure, a first band is supported in the first resonant mode, a second band is supported in the second resonant mode, and a third band is supported in the third resonant mode. The first band, the second band, and the third band are consecutive. Alternatively, two bands of the first band, the second band, and the third band are consecutive. Alternatively, the first band, the second band, and the third band are inconsecutive.

In some embodiments of the disclosure, the first ground point is positioned between the first free end and the feed point.

In some embodiments of the disclosure, the radiator is configured to support a fourth resonant mode, a fifth resonant mode, a sixth resonant mode, and a seventh resonant mode under excitation of the signal source.

In some embodiments of the disclosure, a fourth resonant current in the fourth resonant mode is at least distributed between the first free end and the first coupling end. A direction in which the fourth resonant current flows between the first free end and the first ground point is opposite to a direction in which the fourth resonant current flows between the first ground point and the first coupling end. A fifth resonant current in the fifth resonant mode is at least distributed between the first free end and the first coupling end and between the second coupling end and the second ground point. A direction in which the fifth resonant current flows between the first free end and the first ground point, a direction in which the fifth resonant current flows between the first ground point and the first coupling end, and a direction in which the fifth resonant current flows between the second coupling end and the second ground point are the same with one another. A sixth resonant current in the sixth resonant mode is at least distributed between the first ground point and the first coupling end and between the second coupling end and the second free end. A direction in which the sixth resonant current flows between the first ground point and the first coupling end is opposite to a direction in which the sixth resonant current flows between the second coupling end and the second ground point, a direction in which the sixth resonant current flows between the second ground point and the second free end is opposite to a direction in which the sixth resonant current flows between the second coupling end and the second ground point. A seventh resonant current in the seventh resonant mode is at least distributed between the first ground point and the first coupling end and between the second coupling end and the second free end. A direction in which the seventh resonant current flows between the first ground point and the first coupling end is opposite to a direction in which the seventh resonant current flows between the second coupling end and the second ground point, a direction in which the seventh resonant current flows between the second ground point and the second free end is the same as a direction in which the seventh resonant current flows between the second coupling end and the second ground point.

In some embodiments of the disclosure, the fourth resonant mode is a (⅛˜¼) wavelength mode in which part of the first sub-radiator between the first ground point and the first coupling end operates, the fifth resonant mode is a ½ wavelength mode in which the first sub-radiator operates, and the sixth resonant mode is a (⅛˜¼) wavelength mode in which part of the second sub-radiator between the second coupling end and the second ground point operates, and the seventh resonant mode is a ½ wavelength mode in which the second sub-radiator operates.

In some embodiments of the disclosure, a fourth band is supported in the fourth resonant mode, a fifth band is supported in the fifth resonant mode, a sixth band is supported in the sixth resonant mode, and a seventh band is supported in the seventh resonant mode. The fourth band, the fifth band, the sixth band, and the seventh band are consecutive. Alternatively, three bands of the fourth band, the fifth band, the sixth band, and the seventh band are consecutive. Alternatively, two bands of the fourth band, the fifth band, the sixth band, and the seventh band are consecutive. Alternatively, the fourth band, the fifth band, the sixth band, and the seventh band are inconsecutive.

In some embodiments of the disclosure, a length of part of the radiator between the first ground point and the first free end is (¼˜¾) times a length of the first sub-radiator.

In some embodiments of the disclosure, the antenna assembly further includes a first matching circuit electrically connected between the feed point and the signal source. The first matching circuit includes a first sub-circuit, the first sub-circuit has one end electrically connected to the feed point and another end electrically connected to the reference ground, and the first sub-circuit is capacitive when the first sub-circuit operates in a band supported by the fourth resonant mode, a band supported by the fifth resonant mode, a band supported by the sixth resonant mode, and a band supported by the seventh resonant mode. Alternatively or additionally, the antenna assembly further includes a second matching circuit, and the first sub-radiator further has a first frequency-tuning point positioned between the first free end and the first ground point. The second matching circuit has one end connected to the first frequency-tuning point and another end electrically connected to the reference ground, and the second matching circuit is capacitive when the second matching circuit operates in the band supported by the fourth resonant mode and the band supported by the fifth resonant mode. Alternatively or additionally, the antenna assembly further includes a third matching circuit and the second sub-radiator further has a second frequency-tuning point positioned between the second coupling end and the second ground point. The third matching circuit has one end connected to the second frequency-tuning point and another end electrically connected to the reference ground, and the third matching circuit is capacitive when the third matching circuit operates in the band supported by the fifth resonant mode, the band supported by the sixth resonant mode, and the band supported by the seventh resonant mode. Alternatively or additionally, the antenna assembly further includes a fourth matching circuit and the second sub-radiator further has a third frequency-tuning point positioned between the second ground point and the second free end. The fourth matching circuit has one end connected to the third frequency-tuning point and anther end electrically connected to the reference ground, and the fourth matching circuit is capacitive when the fourth matching circuit operates in the band supported by the sixth resonant mode and the band supported by the seventh resonant mode.

In some embodiments of the disclosure, a length of part of the radiator between the second ground point and the second free end is (¼˜¾) times a length of the second sub-radiator.

In some embodiments of the disclosure, the antenna assembly further includes a direct current block (DC-block) assembly, a filter assembly, and a detection assembly. The DC-block assembly is electrically connected between the first sub-radiator and the signal source and between the first sub-radiator and the reference ground. The filter assembly has one end electrically connected to one side of the DC-block assembly close to the first sub-radiator or electrically connected to the first sub-radiator. Alternatively or additionally, the DC-block assembly is electrically connected between the second sub-radiator and the reference ground, and the filter assembly has one end electrically connected to one side of the DC-block assembly close to the second sub-radiator or electrically connected to the second sub-radiator. The DC-block assembly is configured to isolate the reference ground and block a direct current generated by the signal source. The filter assembly is configured to block a radio frequency (RF) signal transmitted/received by the radiator and to allow an induction signal generated by the radiator in response to approach of a subject to-be-detected to pass through, and the detection assembly is electrically connected to another end of the filter assembly and configured to detect a magnitude of the induction signal.

In a second aspect, an electronic device is provided. The electronic device includes a housing, a reference ground, and at least one antenna assembly of any one of the above embodiments. The reference ground is positioned in the housing. A radiator of the at least one antenna assembly is integrated into the housing, or is disposed on a surface of the housing, or is disposed in a space defined by the housing. The first ground point and the second ground point are both electrically connected to the reference ground.

In some embodiments, the reference ground includes multiple side edges connected in sequence, a joint between each two adjacent side edges is a corner, and the radiator of the at least one antenna assembly is disposed corresponding to two intersected side edges in the plurality of side edges and the corner between the two intersected side edges. Alternatively or additionally, the radiator of the at least one antenna assembly is disposed wholly corresponding to one of the plurality of side edges.

In some embodiments, the at least one antenna assembly includes a first antenna assembly and a second antenna assembly arranged diagonally. The detection assembly is configured to detect both an induction signal generated by the first antenna assembly in response to approach of the subject to-be-detected and an induction signal generated by the second antenna assembly in response to approach of the subject to-be-detected. The electronic device further includes a controller. The controller is electrically connected to the first antenna assembly, the second antenna assembly, and the detection assembly. The controller is configured to adjust a power of the first antenna assembly according to a magnitude of the induction signal generated by the first antenna assembly and to adjust a power of the second antenna assembly according to a magnitude of the induction signal generated by the second antenna assembly.

In some embodiments, the at least one antenna assembly further includes a third antenna assembly and a fourth antenna assembly. At least part of the first antenna assembly, at least part of the second antenna assembly, at least part of the third antenna assembly, and at least part of the fourth antenna assembly are disposed at different sides of the reference ground, respectively. The detection assembly is configured to detect an induction signal generated by the third antenna assembly and an induction signal generated by the fourth antenna assembly in response to approach of the subject to-be-detected. The controller is further electrically connected to the third antenna assembly and the fourth antenna assembly. The controller is configured to determine a mode which the electronic device is currently in according to at least one of the magnitude of the induction signal generated by the first antenna assembly, the magnitude of the induction signal generated by the second antenna assembly, a magnitude of the induction signal generated by the third antenna assembly, and a magnitude of the induction signal generated by the fourth antenna assembly, and to adjust at least one of the power of the first antenna assembly, the power of the second antenna assembly, a power of the third antenna assembly, and a power of the fourth antenna assembly according to the mode. The mode includes at least one of a one-hand holding mode, a two-hand holding mode, a carrying mode, and a head approaching mode.

Technical solutions in embodiments of the disclosure will be described clearly and completely hereinafter with reference to the accompanying drawings in the embodiments of the disclosure. Apparently, the described embodiments are merely some of rather than all of the embodiments of the disclosure. Furthermore, the term “embodiment” or “example” referred to herein means that a particular feature, structure, or characteristic described with reference to the embodiment or example may be included in at least one embodiment of the disclosure. The term “embodiment” or “example” referred to in various points in the specification does not necessarily all refer to the same embodiment, nor does it refer to an independent or alternative embodiment that is mutually exclusive with other embodiments. It is expressly and implicitly understood by those skilled in the art that the embodiments referred to herein can be combined with other embodiments.

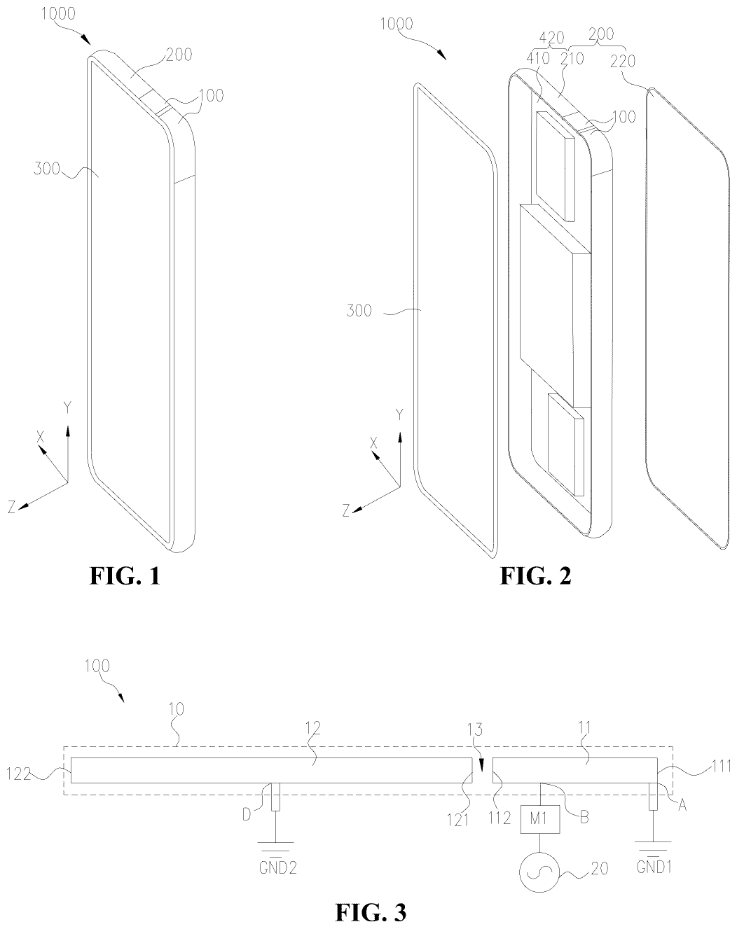

Referring to FIG. 1, FIG. 1 is a schematic structural view of an electronic device provided in embodiments of the disclosure. The electronic device 1000 includes an antenna assembly 100. The antenna assembly 100 is configured to transmit/receive (transmit and/or receive) an electromagnetic wave signal to allow the electronic device 1000 to achieve a communication function. A position of the antenna assembly 100 in the electronic device 1000 is not specifically limited in the disclosure. The electronic device 1000 further includes a display screen 300 and a housing 200 that cover and are connected to each other. The antenna assembly 100 may be disposed inside the housing 200 of the electronic device 1000, or partially integrated with the housing 200, or partially disposed outside the housing 200. As illustrated in FIG. 1, a radiator of the antenna assembly 100 is integrated with the housing 200. Alternatively, the antenna assembly 100 may be attached to a retractable assembly of the electronic device 1000, in other words, at least part of the antenna assembly 100 may also extend out of the electronic device 1000 along with the retractable assembly of the electronic device 1000, and retract into the electronic device 1000 along with the retractable assembly. Alternatively, a length of the entire antenna assembly 100 may increase as the retractable assembly of the electronic device 1000 extends.

The electronic device 1000 includes, but is not limited to, a device that can transmit/receive an electromagnetic wave signal, such as a telephone, a television, a tablet computer, a mobile phone, a camera, a personal computer, a notebook computer, an on-board equipment, an earphone, a watch, a wearable device, a base station, a vehicle-borne radar, and a customer premise equipment (CPE). In the disclosure, the electronic device 1000 is exemplified as a mobile phone, and other devices can refer to the detailed illustration in the disclosure.

For ease of illustration, with reference to a view angle of the electronic device 1000 in FIG. 1, a width direction of the electronic device 1000 is defined as an X-axis direction, a length direction of the electronic device 1000 is defined as a Y-axis direction, and a thickness direction of the electronic device 1000 is defined as a Z-axis direction. The X-axis direction, Y-axis direction, and Z-axis direction are mutually perpendicular. A direction indicated by an arrow is a forward direction.

Referring to FIG. 2, the housing 200 includes a frame 210 and a rear cover 220. A middle plate 410 is formed in the frame 210 through injection molding. The middle plate 410 defines multiple mounting grooves for mounting various electronic components. The middle plate 410 and the frame 210 cooperatively form a middle frame 420 of the electronic device 1000. The display screen 300 and the rear cover 220 both cover the middle frame 420 to define accommodating spaces on two sides of the middle frame 420. A side (for example, a rear side) of the frame 210 surrounds and is connected to a periphery of the rear cover 220, and another side (for example, a front side) of the frame 210 surrounds and is connected to a periphery of the display screen 300. The electronic device 1000 further includes components that can implement basic functions of a mobile phone, such as a battery, a camera, a microphone, a receiver, a speaker, a face recognition module, and a fingerprint recognition module, which are received in the accommodating spaces and will not be repeatedly described in the embodiments.

The antenna assembly 100 provided in the disclosure will be specifically described below with reference to the accompanying drawings. The antenna assembly 100 provided in the disclosure includes, but is not limited to, the following embodiments.

Referring to FIG. 3, the antenna assembly 100 at least includes a radiator 10, a first matching circuit M1, and a signal source 20.

Referring to FIG. 3, the radiator 10 includes a first sub-radiator 11 and a second sub-radiator 12. A coupling gap 13 is defined between the first sub-radiator 11 and the second sub-radiator 12. The first sub-radiator 11 is configured to be coupled to the second sub-radiator 12 through the coupling gap 13. In the embodiment, an example that both the first sub-radiator 11 and the second sub-radiator 12 are in a shape of a linear strip is taken for illustration. In other embodiments, both the first sub-radiator 11 and the second sub-radiator 12 may also be in a shape of a bent strip, a curved strip, a patch, or other shapes.

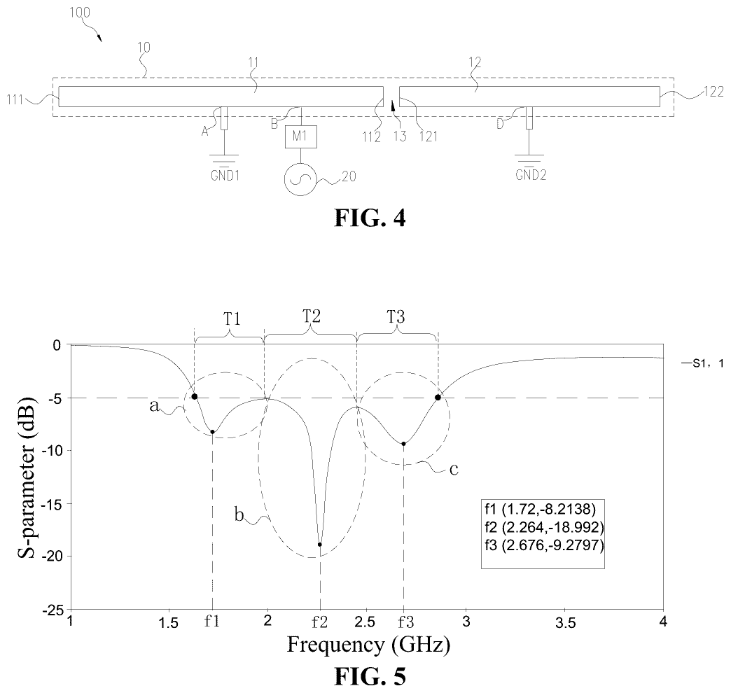

Referring to FIGS. 3 and 4, the first sub-radiator 11 at least includes a first free end 111 and a first coupling end 112. In this embodiment, the first free end 111 and the first coupling end 112 are two opposite ends of the first sub-radiator 11 that is in a shape of a linear strip. In other embodiments, the first sub-radiator 11 is in a bent shape, the first free end 111 and the first coupling end 112 may not be opposite to each other along a straight line, instead the first free end 111 and the first coupling end 112 are two terminals of the first sub-radiator 11, respectively. The first sub-radiator 11 further has a first ground point A and a feed point B. The feed point B is positioned between the first free end 111 and the first coupling end 112. A distance between the first ground point A and the first coupling end 112 is greater than a distance between the feed point B and the first coupling end 112. Specifically, as illustrated in FIG. 4, the first ground point A is positioned between the feed point B and the first free end 111. Alternatively, as illustrated in FIG. 3, the first ground point A is positioned at the first free end 111. The first ground point A is configured to be electrically connected to a first reference ground GND1. The electrical connection between the first ground point A and the first reference ground GND1 may include, but is not limited to, a direct soldering connection, and an indirect electrical connection through a coaxial line, a micro strip line, a conductive elastic piece, a conductive adhesive, or the like. The disclosure does not define a specific position of the first ground point A and a specific position of the feed point B at the first sub-radiator 11.

Referring to FIG. 3, the second sub-radiator 12 at least includes a second coupling end 121, a second free end 122, and a second ground point D positioned between the second coupling end 121 and the second free end 122. In the embodiment, the second coupling end 121 and the second free end 122 are two terminals of the second sub-radiator 12, respectively. Alternatively, the first sub-radiator 11 and the second sub-radiator 12 may be arranged along a straight line, or arranged along a substantially straight line (i.e., a relatively small tolerance is permitted in design). In other embodiments, the first sub-radiator 11 may be staggered with the second sub-radiator 12 in an extending direction, thereby defining a clearance space, among other possibilities.

Referring to FIG. 3, the first coupling end 112 faces and is spaced apart from the second coupling end 121. The coupling gap 13 is defined between the first coupling end 112 and the second coupling end 121. The coupling gap 13 is a gap between the first coupling end 112 of the first sub-radiator 11 and the second coupling end 121 of the second sub-radiator 12. For example, the width of the coupling gap 13 may range from 0.5 mm to 2 mm, but is not limited thereto. The first sub-radiator 11 is configured to be in capacitive coupling with the second sub-radiator 12 through the coupling gap 13. The first sub-radiator 11 and the second sub-radiator 12 may be regarded as two parts of the radiator 10 that are separated by the coupling gap 13 when viewed from a direction.

The first sub-radiator 11 is configured to be in capacitive coupling with the second sub-radiator 12 through the coupling gap 13. Here, “capacitive coupling” means that an electric field may generate between the first sub-radiator 11 and the second sub-radiator 12, a signal of the first sub-radiator 11 can be transmitted to the second sub-radiator 12 through the electric field, and a signal of the second sub-radiator 12 can be transmitted to the first sub-radiator 11 through the electric field, so that an electrical signal can be conducted between the first sub-radiator 11 and the second sub-radiator 12 even in the case where the first sub-radiator 11 is not in contact or connection with the first sub-radiator 11. In the embodiments, the first sub-radiator 11 can generate an electric field under excitation of the signal source 20, and energy of the electric field can be transferred to the second sub-radiator 12 through the coupling gap 13 to excite the second sub-radiator 12 to generate an excitation current.

Referring to FIG. 3, the second ground point D of the second sub-radiator 12 is configured to be electrically connected to a second reference ground GND2.

Referring to FIG. 3, the signal source 20 is electrically connected to the feed point B. Specifically, one end of the first matching circuit M1 is electrically connected to the feed point B. The signal source 20 is electrically connected to another end of the first matching circuit M1. The signal source 20 is an RF transceiver chip configured to transmit an RF signal or a feeder electrically connected to an RF transceiver chip. The first matching circuit M1 may include an adjustable component such as a variable capacitor, and multiple selection branches formed by a switch(s), a capacitor(s), an inductor(s), and a resistor(s).

The signal source 20 is configured to directly feed the RF signal into the first sub-radiator 11. Since the first sub-radiator 11 is in capacitive coupling with the second sub-radiator 12, a current on the first sub-radiator 11 may excite the second sub-radiator 12 to generate an excitation current, so that each of the first sub-radiator 11 and the second sub-radiator 12 have an excitation current. The excitation currents on the first sub-radiator 11 and the second sub-radiator 12 can generate multiple resonant modes.

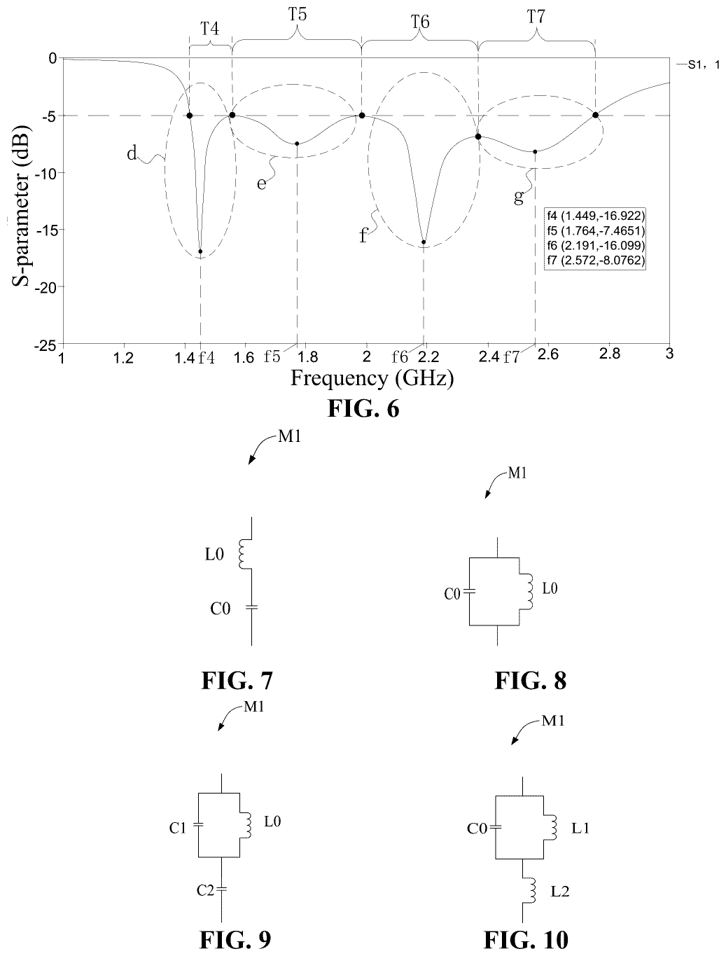

Referring to FIGS. 5 and 6, the radiator 10 is configured to support at least three resonant modes (for example, a resonant mode a, a resonant mode b, and a resonant mode c illustrated in FIG. 5, and for another example, a resonant mode d, a resonant mode e, a resonant mode f, a resonant mode g illustrated in FIG. 6) under excitation of the signal source 20. The resonant mode indicates that the antenna assembly 100 has a high electromagnetic wave transmission/reception efficiency at and around a resonant frequency, where the resonant frequency is a center frequency of the resonant mode. The resonant frequency and frequencies around the resonant frequency cooperatively form a band supported or covered by the resonant mode. Optionally, in a return loss curve, an absolute value of the return loss that is greater than or equal to 5 dB (merely for illustrative purposes and not as a limitation on a return loss for high efficiency in the disclosure) is taken as a reference value for high electromagnetic wave transmission and reception efficiency. A set of frequencies in a resonant mode where the absolute value of the return loss is greater than or equal to 5 dB is considered to be a band supported by the resonant mode.

The band supported by the resonant mode includes 4^{th} generation (4G) long term evolution (LTE) band, 5^{th} generation (5G) New Radio (NR) band, Wi-Fi 6E band, or a combination of the 4G LTE band and the 5G NR band. A band supported by a single resonant mode may be a 4G LTE band (e.g., B3), or a 5G NR band (e.g., N3), or a Wi-Fi 6E band, or a combination of the 4G LTE band and the 5G NR band (e.g., B3/N3).

It is noted that, an increase in the number of resonant modes supported by the antenna assembly 100 has at least the following two advantages. On the one hand, when bands supported by multiple resonant modes of the antenna assembly 100 are all consecutive, the antenna assembly 100 can cover a band of a relatively large bandwidth, thereby forming an ultra-wideband that offers a bandwidth of 1 G, 1.5 G, 2 G, or the like. This achieves ultra-wideband coverage, thereby improving a download bandwidth, improving a throughput download speed, and enhancing a user's network access experience. On the other hand, when bands supported by multiple resonant modes of an antenna assembly 100 are inconsecutive, an increase in the number of bands supported by the antenna assembly 100 can achieve multi-band coverage. For example, the antenna assembly 100 can support both 4G/5G middle-high band (MHB) (for example, ranging from 1000 MHz to 3000 MHz) and 4G/5G ultra-high bands (UHBs) (for example, ranging from 3000 MHz to 10000 MHz), or support MHBs in two different spectrums, or support 4G/5G MHB and WiFi-6E band (for example, ranging 5.925 GHz to 7.125 GHz). The consecutive bands supported by the multiple resonant modes means that two adjacent bands supported by the multiple resonant modes are at least partially overlapped. The inconsecutive bands supported by the multiple resonant modes means that each two adjacent bands supported by the multiple resonant modes are non-overlapped.

In the antenna assembly 100 and the electronic device 1000 provided in the embodiments of the disclosure, the second sub-radiator 12 is in capacitive coupling with the first sub-radiator 11, the second ground point D of the second sub-radiator 12 is designed to be positioned between two ends of the second sub-radiator 12, and the first ground point A of the first sub-radiator 11 is rationally designed to be positioned between two ends of the first sub-radiator 11 or away from an end of a second sub-radiator 12. This enables each of a resonant current on the first sub-radiator 11 and a resonant current on the second sub-radiator 12 to be distributed in multiple manners, thereby supporting multiple resonant modes, and allowing the antenna assembly 100 to support a relatively wide bandwidth or support a relatively large number of bands. As a result, in a case where the antenna assembly 100 is applied to the electronic device 1000, a download bandwidth, a throughput, and a data transmission speed of the electronic device 1000 is provided, thereby improving a communication quality of the electronic device 1000. In addition, when the antenna assembly 100 is relatively wide bandwidth, different bands can be switched without an adjustable component, thereby omitting the adjustable component, saving costs, and simplifying the structure of the antenna assembly 100.

The disclosure does not specifically limit the shape and structure of the first sub-radiator 11 and the second sub-radiator 12. The shape of each of the first sub-radiator 11 and the second sub-radiator 12 includes, but is not limited to, strip-shape, sheet-shape, rod-shape, coating, film, and the like. When the first sub-radiator 11 and the second sub-radiator 12 are each in a shape of a strip, the disclosure does not define a track along which the first sub-radiator 11 and the second sub-radiator 12 extend, and therefore the first sub-radiator 11 and the second sub-radiator 12 may each extend along a track such as a straight line, a curve, or multiple bends. Along the track, the above-mentioned radiator 10 may be in shape of a line with a uniform width, or may also be in a shape of a strip that gradually changes in width, or may be in a shape of a strip that changes in width and has a widened region.

The first ground point A and the second ground point D of the antenna assembly 100 can be electrically connected to a reference ground through various embodiments, including but not limited to the following. Optionally, the antenna assembly 100 may have a reference ground integrated with the antenna assembly 100, where the reference ground but is not limited to, a metal plate, a metal layer formed within a flexible circuit board or a rigid circuit board, and the like. Optionally, the first ground point A and the second ground point D can be electrically connected to the reference ground through a conductive member such as a grounding elastic piece, solder, and a conductive adhesive. In some embodiments of the disclosure, the first reference ground GND1 and the second reference ground GND2 may be an integrally into one reference ground in the antenna assembly 100, or may be two independent reference grounds connected with each other in the antenna assembly 100. In a case where the antenna assembly 100 is disposed in the electronic device 1000, the reference ground of the antenna assembly 100 is electrically connected to a reference ground of the electronic device 1000. Optionally, the antenna assembly 100 is not integrated with a reference ground, and the first ground point A and the second ground point D of the antenna assembly 100 may be electrically connected or indirectly connected via conductive components to the reference ground of the electronic device 1000 or a reference ground of an electronic component in the electronic device 1000. In the disclosure, the antenna assembly 100 is mounted to the electronic device 1000, and a metal alloy of the middle plate 410 may serve as the reference ground. That is, the first reference ground GND1 and the second reference ground GND2 are part of, or are electrically connected to, the middle plate 410.

In conventional technology, antennas often have insufficient effective bandwidth, for example, in the MHB (1000 MHz˜3000 MHz). As an example, a band of 1710 MHz˜12690 MHz (corresponding to B3/N3+B1/N1+B7/N7) is taken for illustration. In practical use, antenna mounting is constrained due to a limited space, an antenna capable of generating two resonant modes is generally used to support the foregoing band. However, due to a relatively narrow width of a band supported by each resonant mode, achieving a coverage of a band of 1710 MHz to 2690 MHz requires center frequencies of the two resonant modes to be separated by a relatively large interval. Consequently, bands between center frequencies of the two resonant modes will be far away from the center frequencies of the two resonant modes and thus have relatively low efficiencies, that is, an efficiency in an intermediate band (for example, a band of 1.9 GHz˜2.1 GHz corresponding to B1/N1) of the foregoing band is relatively low. In a case where a tuning circuit is employed to tune an offset of a resonant mode to shift the central frequency of the resonant mode closer to the band of 1.9 GHz 2.1 GHz (corresponding to B1/N1), an efficiency in the band of 1.9 GHz˜2.1 GHz (corresponding to B1N1) is improved, but an efficiency in other bands is reduced. In other words, in conventional technology, it is difficult for an antenna to achieve a relatively high efficiency in B3/N3+B1N1, or in B1/N1+B7/N7, let alone in B3/N3+B1/N1+B7/N7. This results in poor signal transmission and reception of the antenna in some bands, or requires additional radiators to support more bands, where the additional radiators will make the antenna less compact. It is noted that the above bands are merely exemplary, and cannot be taken as a limitation to the bands that can be covered in the disclosure.

In the antenna assembly 100 provided in the disclosure, structures of the first sub-radiator 11 and the second sub-radiator 12 and a position of the second ground point D are designed, so that the resonant current densities of the first sub-radiator 11 and the second sub-radiator 12 can be distributed in various manners. This allows the antenna assembly 100 to have a simple structure and a small overall size, and also support multiple resonant modes (e.g., three or more resonant modes). In comparison to the conventional antenna designed to support the band of 1710 MHz˜2690 MHz, the antenna assembly 100 provided in the disclosure can support three or more resonant modes and thus has a relatively high efficiency across the entire band of 1710 MHz˜2690 MHz. Thus, in practice, the antenna assembly 100 can cover B3/N3+B1/N1 with a relatively high efficiency, cover B1/N1+B7/N7 with a relatively high efficiency, and cover B3/N3+B1/N1+B7/N7 with a relatively high efficiency. Furthermore, the number of sub-radiators of the antenna assembly 100 provided in the disclosure is relatively small, three or more resonant modes can be generated without increasing the number of sub-radiators. In other words, the antenna assembly 100 provided in the disclosure has a simple structure, a small overall size, facilitating arrangement of the antenna assembly 100 within a limited internal space of an electronic device 1000 and achievement of a relatively high efficiency across the entire band of 1710 MHz˜2690 MHz. B3/N3 includes either B3 or N3, as well as both B3 and N3. The definitions of B1/N1 and B7/N7 are similar to B3/N3, and are not further described herein. The above band of 1710 MHz˜2690 MHz is merely exemplary in the disclosure. In other embodiments, by adjusting a size of the first sub-radiator 11 and a size of the second sub-radiator 12, the antenna assembly 100 can also have a relatively high-efficiency coverage across bands of 1000 MHz˜2000 MHz, 3000 MHz˜4000 MHz, 4000 MHz˜5000 MHz, 5000 MHz˜6000 MHz, or more than 6000 MHz.

A specific position of the second ground point D is not limited in the disclosure. By arranging the second ground point D to be between the second free end 122 and the second coupling end 121, the second sub-radiator 12 and a grounding branch can form a T-shaped antenna. An excitation current provided by the signal source 20 allows a current distribution with the monopole and dipole characteristics to be formed on the T-shaped second sub-radiator 12, to excite multiple resonant modes. The second ground point D may be positioned close to the geometrical center of the second sub-radiator 12. For example, a distance between the second ground point D and the second free end 122 is (¼˜¾) times a length of the second sub-radiator 12. In other words, the second ground point D may be positioned at a distance ranging from ¼ to ¾ of the length of the second sub-radiator 12 from the second free end 122. By the above design or in combination with the design of a matching circuit of the second sub-radiator 12 (which will be described in detail hereinafter), the second sub-radiator 12 can form multiple resonant current distributions with characteristics such as monopole and dipole to support multiple resonant modes, thereby generating a relatively wide bandwidth, and improving the throughput and a quantitative transmission rate. In addition, the second ground point D can be positioned at a position within a relatively large range, so that there is a relatively large range for positioning a ground connecting component. Thus, during mounting of the antenna assembly 100 to the electronic device 1000, the ground connecting component can be positioned in a relatively large range, thereby facilitates mounting of the antenna assembly 100 to the electronic device 1000. The above ¼ and ¾ times are merely exemplary, and are not limited thereto. In other embodiments, the distance between the second ground point D and the second free end 122 may be slightly smaller than ¼ of the length of the second sub-radiator 12, or slightly greater than ¾ of the length of the second sub-radiator 12.

Alternatively, the distance between the second ground point D and the second free end 122 is (⅜˜⅝) times the length of the second sub-radiator 12. In other words, the second ground point D may be positioned at a distance ranging from ⅜ to ⅝ of the length of the second sub-radiator 12 from the second free end 122. With the above design, the second ground point D can be positioned closer to a middle portion of the second sub-radiator 12 (which is not positioned in the middle of the second sub-radiator 12). This facilitates a form of a current distribution of a monopole mode and a dipole mode, thereby widening the bandwidth of the antenna assembly 100 and improving the efficiency of the antenna assembly 100.

The disclosure does not specifically limit the structure of the first matching circuit M1. The first matching circuit M1 may include a frequency selection filter circuit. The frequency selection filter circuit is configured to perform frequency selection on RF signals transmitted by the signal source 20 to acquire an RF signal of a required band (for example, an RF signal of 1 GHz˜4 GHz).

Referring to FIGS. 7 to 14, FIGS. 7 to 14 are schematic diagrams of a first matching circuit M1 according to various embodiments. The disclosure does not limit a specific structure of the first matching circuit M1. The first matching circuit M1 includes one or more of the following frequency selection filter circuits.

Referring to FIG. 7, the first matching circuit M1 includes a band-pass circuit formed by an inductor L0 and a capacitor C0 connected in series.

Referring to FIG. 8, the first matching circuit M1 includes a band-stop circuit formed by an inductor L0 and a capacitor C0 connected in parallel.

Referring to FIG. 9, the first matching circuit M1 includes a band-pass or band-stop circuit formed by an inductor L0, a first capacitor C1, and a second capacitor C2. The inductor L0 is connected in parallel to the first capacitor C1, and the second capacitor C2 is electrically connected to a node where the inductor L0 is electrically connected to the first capacitor C1.

Referring to FIG. 10, the first matching circuit M1 includes a band-pass or band-stop circuit formed by a capacitor C0, a first inductor L1, and a second inductor L2. The capacitor C0 is connected in parallel to the first inductor L1, and the second inductor L2 is electrically connected to a node where the capacitor C0 is electrically connected to the first inductor L1.

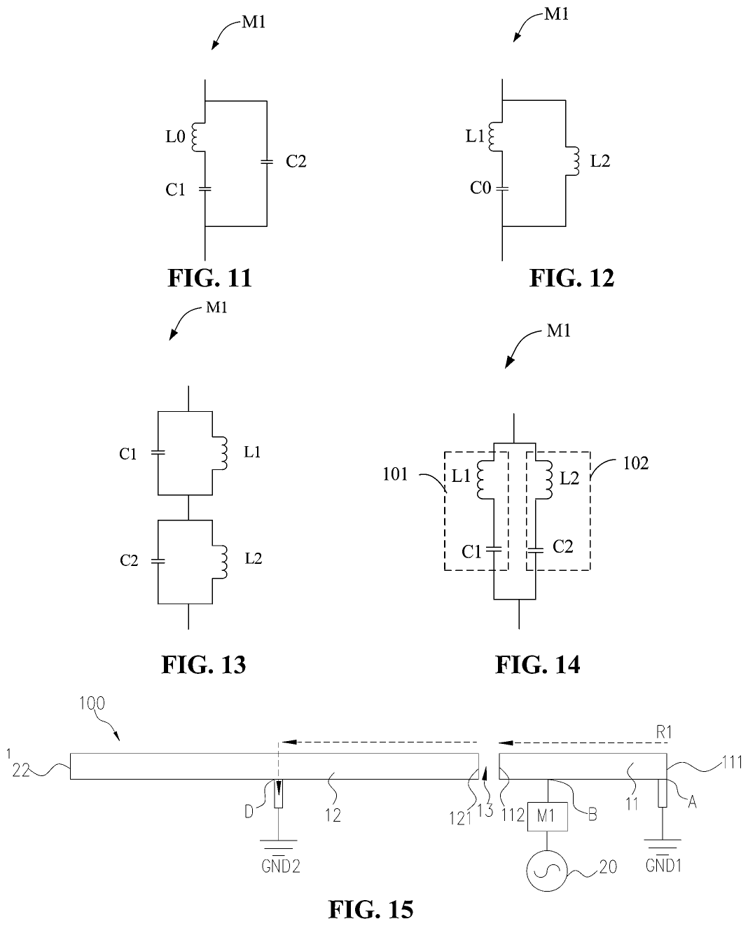

Referring to FIG. 11, the first matching circuit M1 includes a band-pass or band-stop circuit formed by an inductor L0, a first capacitor C1, and a second capacitor C2. The inductor L0 is connected in series to the first capacitor C1, one end of the second capacitor C2 is electrically connected to a first end of the inductor L0 that is not connected to the first capacitor C1, and another end of the second capacitor C2 is electrically connected to one end of the first capacitor C1 that is not connected to the inductor L0.

Referring to FIG. 12, the first matching circuit M1 includes a band-pass or band-stop circuit formed by a capacitor C0, a first inductor L1, and a second inductor L2. The capacitor C0 is connected in series to the first inductor L1, one end of the second inductor L2 is electrically connected to one end of the capacitor C0 that is not connected to the first inductor L1, and the other end of the second inductor L2 is electrically connected to one end of the first inductor L1 that is not connected to the capacitor C0.

Referring to FIG. 13, the first matching circuit M1 includes a first capacitor C1, a second capacitor C2, a first inductor L1, and a second inductor L2. The first capacitor C1 is connected in parallel to the first inductor L1, the second capacitor C2 is connected in parallel to the second inductor L2, and one end of a combination of the second capacitor C2 and the second inductor L2 connected in parallel is electrically connected to one end of a combination of the first capacitor C1 and the first inductor L1 connected in parallel.

Referring to FIG. 14, the first matching circuit M1 includes a first capacitor C1, a second capacitor C2, a first inductor L1, and a second inductor L2. The first capacitor C1 and the first inductor L1 are connected in series to form a first unit 101, the second capacitor C2 and the second inductor L2 are connected in series to form a second unit 102, and the first unit 101 is connected in parallel to the second unit 102.

The first matching circuit M1 is configured to select an RF signal of a required band (e.g., an RF signal of 1 GHz˜3 GHz or an RF signal of 1 GHz˜4 GHz) through the above one or more frequency selection filter circuits, and to transmit the RF signal selected to the first sub-radiator 11 and the second sub-radiator 12, so that the first sub-radiator 11 and the second sub-radiator 12 can transmit/receive electromagnetic wave signals required.

A specific structure of the antenna assembly 100 provided in the disclosure includes, but is not limited to, the following embodiments.

FIG. 3 illustrates the antenna assembly 100 provided in an embodiment, where the first ground point A of the first sub-radiator 11 is positioned at the first free end 111. The first sub-radiator 11 and a ground path of the first sub-radiator 11 form a substantially L-shaped branch. The second ground point D of the second sub-radiator 12 is positioned between the second coupling end 121 and the second free end 122. The second sub-radiator 12 and a ground path of the second sub-radiator 12 form a substantially T-shaped branch.

The following describes resonant modes generated by the antenna assembly 100 with reference to a return loss curve of the antenna assembly 100 in FIG. 3.

Referring to FIG. 5, the radiator 10 may support three resonant modes under excitation of the signal source 20, where the three resonant modes are a first resonant mode a, a second resonant mode b, and a third resonant mode c. A center frequency of the first resonant mode a is a first frequency f1, a center frequency of the second resonant mode b is a second frequency f2, and a center frequency of the third resonant mode c is a third frequency f3. Each adjacent two frequencies among the first frequency f1, the second frequency f2, and the third frequency f3 are spaced apart from each other by an appropriate interval. Optionally, the first frequency f1, the second frequency f2, and the third frequency f3 increase sequentially. In the return loss curve, an absolute value of a return loss that is greater than or equal to 5 dB is taken as a reference value for high electromagnetic wave transmission and reception efficiency. In this way, a first band T1 is supported by the first resonant mode a, a second band T2 is supported by the second resonant mode b, and a third band T3 is supported by the third resonant mode c.

In this embodiment, the first band T1, the second band T2, and the third band T3 are consecutive. Thus, a bandwidth of a combination of a band supported by the first resonant mode a, a band supported by the second resonant mode b, and a band supported by the third resonant mode c is equal to a sum of a bandwidth of the first band T1, a bandwidth of the second band T2, and a bandwidth of the third band T3, thereby forming a bandwidth greater than 1 GHz, for example, a bandwidth of 1.3 GHz.

In terms of common bands, the antenna assembly 100 in this embodiment can be applied to cover a band of 1.6 GHz˜2.9 GHz to support multiple different bands planned by various groups of operators such as B1, B3, B7, N1, N3, and N7. This is beneficial to meeting band allocation requirements of different operators.

Referring to FIG. 5, the center frequency of the first resonant mode a is about 1.724 GHz, and the first band T1 is about 1.62 GHz˜1.98 GHz. The first resonant mode a can support B3/N3. The center frequency of the second resonant mode b is about 2.264 GHz, and the second band T2 is about 1.98 GHz˜2.46 GHz. The second resonant mode b can support B1/N1. A center frequency of the third resonant mode c is about 2.676 GHz, and the third band T3 is about 2.46 GHz˜2.88 GHz. The third resonant mode c can support B7/N7. It can be seen from FIG. 5 that the first band T1, the second band T2, and the third band T3 are consecutive and combined to form a target application band. The target application band can cover 1.6 GHz˜2.9 GHz, and thus can support a bandwidth of 1.3 G. It is noted that, by adjusting an effective electrical length and a feed position of the radiator 10, the target application band can also be adjusted to be, but is not limited to, 1.6 GHz˜3 GHz, 2 GHz˜3.4 GHz, 2.6 GHz˜4 GHz, 3.6 GHz˜5 GHz, etc. Additionally, the bandwidth of the target application band can be, but is not limited to, 1.8 G, 2 G, 2.5 G, 3 G, etc.

When the target application band covers 1.6 GHz˜3 GHz, 4G LTE bands supported by the antenna assembly 100 include, but are not limited to, at least one of B1, B2, B3, B4, B7, B32, B38, B39, B40, B41, B48, and B66; 5G NR bands supported by the antenna assembly 100 include, but are not limited to, at least one of N1, N2, N3, N4, N7, N32, N38, N39, N40, N41, N48, and N66. The antenna assembly 100 provided in the disclosure can cover any combination of the above-mentioned NR 5G bands and the above-mentioned 4G LTE bands. The antenna assembly 100 may transmit/receive only 4G LTE signals (e.g., signals in B1, B3, and B7 bands). Alternatively, the antenna assembly 100 may transmit/receive only 5G NR signals (e.g., signals in N1, N3, and N7 bands). Alternatively, the antenna assembly 100 may transmit/receive both 4G LTE signals and 5G NR signals (e.g., signals in B1, N3, and B7 bands), thereby achieving a dual connection between the 4G radio access network and the 5G-NR (EN-DC). When the antenna assembly 100 can transmit/receive 4G LTE signals or 5G NR signals individually, bands in which the antenna assembly 100 transmits/receives signals are formed by combining multiple carriers (the carrier is a radio wave of a specific frequency), that is, carrier aggregation (CA) is achieved, thereby increasing a transmission bandwidth, improving a throughput, and improving a signal transmission rate.

The above-mentioned bands may be the MHB that may be adopted by multiple operators. The antenna assembly 100 provided in the disclosure may support any one or combination of the above-mentioned bands to enable the antenna assembly 100 provided in the disclosure to support different models of the electronic device 1000 corresponding to multiple different operators, thus there is no need to use different antenna structures for different operators, thereby further improving the application range and compatibility of the antenna assembly 100.

In other embodiments, the antenna assembly 100 may also be applied to a band of 5.925 GHz˜7.125 GHz to support the WiFi-6E band, etc.

In other embodiments, one band of the first band T1, the second band T2, and the third band T3 may be inconsecutive with the other two bands, or each two bands of the first band T1, the second band T2, and the third band T3 may be inconsecutive with each other. For example, for a coverage of B3N3+B1/N1+B7/N7, B3/N3 is a band of 1.71 GHz˜1.785 GHz, and B1/N1 is a band of 1.92 GHz 1.98 GHz, and B7/N7 is a band of 2.5 GHz˜2.57 GHz. Therefore, relatively high efficiency may not be required in a band of 2.0 GHz˜2.5 GHz, and the second band T2 and the third band T3 may be inconsecutive in the band of 2.0 GHz˜2.5 GHz. In comparison to that the first band T1, the second band T2, and the third band T3 are consecutive, this allows the third resonant mode c to cover higher frequencies. In addition, since relatively high efficiency is also not required in a band of 1.8 GHz˜1.9 GHz, a tuning can be performed to enable the first band T1 to cover 1.71 GHz˜1.785 GHz, the second band T2 to cover 1.92 GHz˜1.98 GHz, and the third band T3 to cover 2.5 GHz˜2.57 GHz. Thus, the first band T1 and the second band T2 may be inconsecutive in a band of 1.8 GHz˜1.9 GHz, and the second band T2 and the third band T3 may be inconsecutive in a band of 2.0 GHz˜2.5 GHz. In other embodiments, a tuning can be performed to enable the first band T1 and the second band T2 to support the MHB such as B3/N3+B1/N1 and enable the third band T3 to support the UHB such as N78 (3.3 GHz˜3.8 GHz). Specific embodiments of position adjustment for performing tuning on the first band T1, the second band T2, and the third band T3 are described in the following.

The first resonant mode a, the second resonant mode b, and the third resonant mode c are described below from a perspective of current distribution.

Referring to FIG. 15, a first resonant current R1 in the first resonant mode a is mainly distributed between the first ground point A and the first coupling end 112 and between the second coupling end 121 and the second ground point D. A direction in which the first resonant current R1 flows between the first ground point A and the first coupling end 112 is the same as a direction in which the first resonant current R1 flows between the second coupling end 121 and the second ground point D. Specifically, referring to FIG. 15, the first resonant current R1 flows from the first reference ground GND1 to the first ground point A, then flows from the first ground point A to the first coupling end 112 along the first sub-radiator 11, then flows from the first coupling end 112 to the second coupling end 121 through the coupling gap 13, then flows from the second coupling end 121 to the second ground point D, and then flows from the second ground point D to the second reference ground GND2. Alternatively, the first resonant current R1 flows from the second reference ground GND2 to the second ground point D, then flows from the second ground point D to the second coupling end 121, then flows from the second coupling end 121 to the first coupling end 112 through the coupling gap 13, then flows from the first coupling end 112 to the first ground point A, and then flows from the first ground point A to the first reference ground GND1. It is noted that, the first resonant current R1 is mainly distributed on the first sub-radiator 11 and part of the second sub-radiator 12 between the second ground point D and one end of the second sub-radiator 12 close to the first sub-radiator 11. Additionally, a small part of the first resonant current R1 may flow to another part of the second sub-radiator 12 between the second ground point D and one end of the second sub-radiator 12 away from the first sub-radiator 11, but has an extremely low current density. The first resonant current R1 is distributed to excite the first resonant mode.

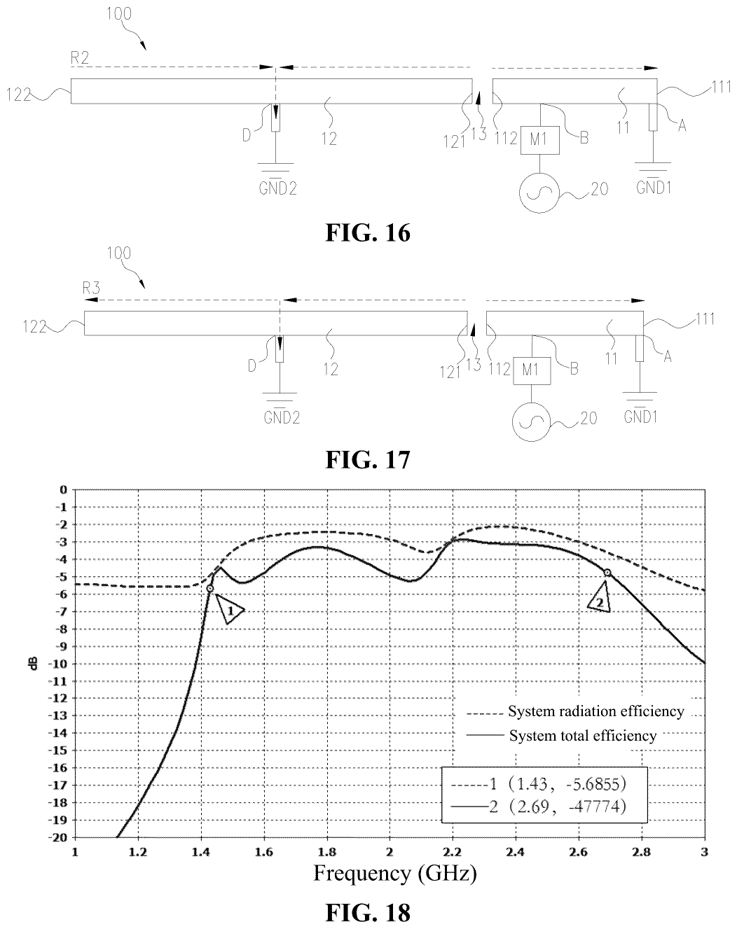

Referring to FIG. 16, a second resonant current R2 in the second resonant mode b is distributed between the first ground point A and the first coupling end 112 and between the second coupling end 121 and the second free end 122. A direction in which the second resonant current R2 flows between the first ground point A and the first coupling end 112 is opposite to a direction in which the second resonant current R2 flows between the second coupling end 121 and the second ground point D. A direction in which the second resonant current R2 flows between the second ground point D and the second free end 122 is opposite to a direction in which the second resonant current R2 flows between the second coupling end 121 and the second ground point D. Specifically, a first part of the second resonant current R2 flows from the first coupling end 112 to the first ground point A, and then flows from the first ground point A to the ground; a second part of the second resonant current R2 flows from the second coupling end 121 to the second ground point D, and then flows from the second ground point D to the ground; and a third part of the second resonant current R2 flows from the second free end 122 to the second ground point D, and then flows from the second ground point D to ground. Alternatively, a first part of the second resonant current R2 flows from the first reference ground GND1 to the first ground point A, and then flows from the first ground point A to the first coupling end 112; a second part of the second resonant current R2 flows from the second reference ground GND2 to the second ground point D, and then flows from the second ground point D to the second coupling end 121; and a third part of the second resonant current R2 flows from the second ground point D to the second free end 122. The second resonant current R2 is distributed to excite the second resonant mode b. The second sub-radiator 12 is a T-shaped antenna, currents at two sides of the second ground point D of the second sub-radiator 12 flow in opposite directions, and thus the T-shaped antenna has a monopole characteristic. The monopole characteristic enables the second sub-radiator 12 to excite a large amount of ground (i.e., reference ground) current. This enhances the radiation efficiency, leading to generation of the second resonant mode b at the second frequency f2.

Referring to FIG. 17, a third resonant current R3 in the third resonant mode c is distributed between the first ground point A and the first coupling end 112 and between the second coupling end 121 and the second free end 122. A direction in which the third resonant current R3 flows between the first ground point A and the first coupling end 112 is opposite to a direction in which the third resonant current R3 flows between the second coupling end 121 and the second ground point D. A direction in which the third resonant current R3 flows between the second ground point D and the second free end 122 is the same as a direction in which the third resonant current flows between the second coupling end 121 and the second ground point D. Specifically, a first part of the third resonant current R3 flows from the first coupling end 112 to the first ground point A, and then flows from the first ground point A to the ground; a second part of the third resonant current R3 flows from the second coupling end 121 to the second ground point D, and then flows from the second ground point D to the ground; and a third part of the third resonant current R3 flows from the second ground point D to the second free end 122. Alternatively, a first part of the third resonant current R3 flows from the first reference ground GND1 to the first ground point A, and then flows from the first ground point A to the first coupling end 112; a second part of the third resonant current R3 flows from the second reference ground GND2 to the second ground point D, and then flows from the second ground point D to the second coupling end 121; and a third part of the third resonant current R3 flows from the second free end 122 to the second coupling end 121. In another embodiment, a first part of the third resonant current R3 flows from the first reference ground GND1 to the first ground point A, and then flows from the first ground point A to the first coupling end 112; a second part of the third resonant current R3 flows from the second reference ground GND2 to the second ground point D, and then flows from the second ground point D to the second coupling end 121; and a third part of the third resonant current R3 flows from the second free end 122 to the second ground point D. The third resonant current R3 is distributed to excite the third resonant mode c. The second sub-radiator 12 is a T-shaped antenna, currents at two sides of the second ground point D of the second sub-radiator 12 flow in the same direction, and thus the T-shaped antenna has a dipole characteristic. The dipole characteristic enables a relatively high radiation efficiency, leading to a generation of the third resonant mode c at the third frequency f3.

It is noted that, in view of resonant current distribution of the first resonant mode a, the second resonant mode b, and the third resonant mode c, part of the resonant current corresponding to the first resonant mode a, part of the resonant current corresponding to the second resonant mode b, and part of the resonant current corresponding to the third resonant mode c have the same direction of flow (e.g., a direction from the second coupling end 121 to the second ground point D). As such, mutual enhancement among the first resonant mode a, the second resonant mode b, and the third resonant mode c may be achieved, thereby widening the bandwidth of the antenna assembly 100.

The generation of the first resonant mode a, the second resonant mode b, and the third resonant mode c will be described hereinafter from the perspective of wavelength modes corresponding to the first resonant frequency f1, the second resonant frequency f2, and the third resonant frequency f3.

Referring to FIGS. 5 and 15, a wavelength corresponding to the center frequency of the first resonant mode a is a first wavelength. Optionally, the first resonant mode a is a (⅛˜¼) wavelength mode in which the first sub-radiator 11 operates. Specifically, a length of the first sub-radiator 11 is about (⅛˜¼) times the first wavelength. In other words, the length of the first sub-radiator 11 is about (⅛˜¼) times a wavelength corresponding to the first frequency f1. In a case where a matching circuit for adjusting a frequency shift is absent from a flow path of the first resonant current R1, the length of the first sub-radiator 11 is about (¼) times the wavelength corresponding to the first frequency f1, so that the first sub-radiator 11 can achieve high transmission and reception efficiency at the first frequency f1 and in turn resonate at the first frequency f1, thereby generating the first resonant mode a. In a case where a matching circuit, which is grounded and capacitive when the matching circuit operates in the first band T1, is disposed on the flow path of the first resonant current R1, capacitive loading may enable the resonant frequency to shift towards a low frequency, so that the length of the first sub-radiator 11 that allows generation of the resonance at the first frequency f1 can be shortened, for example, reduced to (⅛) times the wavelength corresponding to the first frequency f1, thereby further reducing the size of the first sub-radiator 11. In addition, a capacitive circuit connected to the ground may also be disposed in the first matching circuit M1, and capacitive loading is performed in a region where the first resonant current R1 flows, so that the resonant frequency may shift towards a low frequency, and therefore, the length of the first sub-radiator 11 that allows generation of the resonance at the first frequency f1 can be shortened, for example, reduced to (⅛) times the wavelength corresponding to the first frequency f1.

Optionally, referring to FIGS. 5 and 16, a wavelength corresponding to the center frequency of the second resonant mode b is a second wavelength. The second resonant mode b is a (⅛˜¼) wavelength mode in which part of the second sub-radiator 12 between the second coupling end 121 and the second ground point D operates. Specifically, a length of the part of the second sub-radiator 12 between the second coupling end 121 and the second ground point D is about (⅛˜¼) times the second wavelength. In other words, the length of the part of the second sub-radiator 12 between the second coupling end 121 and the second ground point D is about (⅛˜¼) times a wavelength corresponding to the second frequency f2. In a case where a matching circuit for adjusting a frequency shift is absent from a flow path of the second resonant current R2, the length of the part of the second sub-radiator 12 between the second coupling end 121 and the second ground point D is about (¼) times the wavelength corresponding to the second frequency f2, so that the part of the second sub-radiator 12 between the second coupling end 121 and the second ground point D can achieve high transmission and reception efficiency at the second frequency f2 and in turn resonate at the second frequency f2, thereby generating the second resonant mode b. In a case where a matching circuit, which is grounded and capacitive when the matching circuit operates in the second band T2, is disposed on the current path of the second resonant current R2, capacitive loading may enable the resonant frequency to shift towards a low frequency, so that the length of the part of the second sub-radiator 12 between the second coupling end 121 that allows generation of the resonance at the second frequency f2 is shortened, for example, reduced to (⅛) times the wavelength corresponding to the second frequency f2, thereby further reducing the size of the second sub-radiator 12. In addition, a capacitive circuit connected to the ground may also be disposed in the first matching circuit M1, and capacitive loading is performed in a region where the second resonant current R2 flows, so that the resonant frequency may shift towards a low frequency, and therefore, a length of the part of the second sub-radiator 12 between the second coupling end 121 and the second ground point D that allows generation of the resonance at the second frequency f2 can be shortened to less than (⅛) times the wavelength corresponding to the second frequency f2.

Optionally, referring to FIGS. 5 and 17, a wavelength corresponding to the center frequency of the third resonant mode c is a third wavelength. The third resonant mode c is a (½) wavelength mode in which the second sub-radiator 12 operates. The length of the second sub-radiator 12 is about (½) times the third wavelength. In a case where a matching circuit for adjusting a frequency is absent, the length of the second sub-radiator 12 is about (½) times the third wavelength, thereby allowing the antenna assembly 100 to achieve relatively high signal transmission and reception efficiency at the second frequency f2 and the third frequency f3. Further, by providing a capacitive matching circuit that is grounded on a distribution path of the third resonant current R3, the length of the second sub-radiator 12 can be further shortened.

Further, by adjusting the length of the first sub-radiator 11, the length of the second sub-radiator 12, the position of the feed point B, and the position of the second ground point D, the first frequency f1, the second frequency f2, and the third frequency f3 can be shifted towards each other, so that the first band T1, the second band T2, and the third band T3 can be consecutive. This can support a relatively wide bandwidth, and cover a band required, thereby improving a throughput of the antenna assembly 100 and an Internet access rate of the electronic device 1000.

In an embodiment of the antenna assembly 100, referring to FIGS. 4 and 6, the first ground point A of the first sub-radiator 11 is positioned between the first free end 111 and the first coupling end 112. The first sub-radiator 11 and a ground path of the first sub-radiator 11 form a substantially T-shape branch. The disclosure does not define a specific position of the first ground point A between the first free end 111 and the first coupling end 112. Optionally, a distance between the first ground point A and the first free end 111 is (¼˜¾) times the length of the first sub-radiator 11. Optionally, the distance between the first ground point A and the first free end 111 is (⅜˜⅝) times the length of the first sub-radiator 11. The first ground point A can be positioned close to the geometrical center of the first sub-radiator 11, facilitating formation of a resonant current distribution of a monopole mode and a dipole mode, widening the bandwidth of the antenna assembly 100, and improving the efficiency of the antenna assembly 100.

The second ground point D of the second sub-radiator 12 is positioned between the second coupling end 121 and the second free end 122. The second sub-radiator 12 and a ground path of the second sub-radiator 12 form a substantially T-shaped branch.

The following describes resonant modes generated by the antenna assembly 100 with reference to a return loss curve of the antenna assembly 100 in FIG. 4.

Referring to FIGS. 4 and 6, the radiator 10 may support four resonant modes under excitation of the signal source 20, where the four resonant modes are a fourth resonant mode d, a fifth resonant mode e, a sixth resonant mode f and a seventh resonant mode g. A center frequency of the fourth resonant mode d is a fourth frequency f4, a center frequency of the fifth resonant mode e is a fifth frequency f5, a center frequency of the sixth resonant mode f is a sixth frequency f6, and a center frequency of the seventh resonant mode g is a seventh frequency f7. Each adjacent two frequencies among the fourth frequency f4, the fifth frequency f5, the sixth frequency f6, and the seventh frequency f7 are spaced apart from each other by an appropriate interval. Optionally, the fourth frequency f4, the fifth frequency f5, the sixth frequency f6, and the seventh frequency f7 increase sequentially. In the return loss curve, an absolute value of a return loss that is greater than or equal to 5 dB is taken as a reference value for high electromagnetic wave transmission and reception efficiency. In this way, a fourth band T4 is supported by the fourth resonant mode d, a fifth band T5 is supported by the fifth resonant mode e, a sixth band T6 is supported by the sixth resonant mode f and a seventh band T7 is supported by the seventh resonant mode g.

In comparison to the antenna assembly 100 in FIG. 3, in this embodiment, a position of the first ground point A is changed, so that the first sub-radiator 11 and the second sub-radiator 12 can generate more resonant current distribution modes, thereby supporting four resonant modes. An increase in the number of the resonant modes can further widen the bandwidth of the antenna assembly 100 and improve the efficiency of the antenna assembly 100 within the bandwidth.

Referring to FIG. 6, the center frequency of the fourth resonant mode d is about 1.449 GHz, and the fourth band T4 is about 1.41 GHz˜1.56 GHz. The fourth resonant mode d can support bands such as B32 (1.452 GHz˜1.496 GHz), B21 (1.447 GHz˜1.51 GHz), and N75 (1.43 GHz˜1.517 GHz). The central frequency of the fifth resonant mode e is about 1.764 GHz, and the fifth band T5 is about 1.56 GHz˜1.98 GHz. The fifth resonant mode e can support bands such as B3/N3. The center frequency of the sixth resonant mode f is about 2.191 GHz, and the sixth band T6 is about 1.98 GHz 2.36 GHz. The sixth resonant mode f can support bands such as B1/N1. The central frequency of the seventh resonant mode g is about 2.572 GHz, and the seventh resonant mode T7 is about 2.36 GHz 2.74 GHz. The seventh resonant mode g can support bands such as B7/N7 and N41. It is noted that, the center frequency of each resonant mode and the band supported by each resonant mode are described according to the curve in FIG. 6. The data of the curve in FIG. 6 are merely exemplary, and the center frequency of each resonant mode and the band supported by each resonant mode may be adjusted by adjusting the length of the first sub-radiator 11, the length of the second sub-radiator 12, the position of the feed point B, the position of the first ground point A, the position of the second ground point D, setting a tuning matching circuit that is grounded, or the like.

Referring to FIG. 6, in this embodiment, the fourth band T4, the fifth band T5, the sixth band T6, and the seventh band T7 are consecutive in sequence to form a target application band with a relatively wide bandwidth (e.g., 1.3 G) through combination, and the target application band covered is 1.42 GHz˜2.76 GHz. It is noted that, by adjusting effective electrical lengths and feeding positions of the first sub-radiator 11 and the second sub-radiator 12, and positions of the first ground point A and the second ground point D, the target application band may also be adjusted to include, but not limited to, 1.6 GHz˜3 GHz, 2 GHz˜3.4 GHz, 2.6 GHz˜4 GHz, 3.6 GHz˜5 GHz, and the like, and a bandwidth of the target application band may also be adjusted to include, but not limited to, 1.8 G, 2 G, 2.5 G, 3 G, and the like.

In terms of common bands, the antenna assembly 100 in FIG. 4 can be applied to a band of 1.42˜2.76 GHz to support a 5G NR band and a 4G LTE band that are planned by multiple groups of operators and belong to a band of 1.42˜2.76 GHz, for example, B32 (1.452 GHz˜1.496 GHz), B21 (1.447 GHz˜1.51 GHz), B1, B3, B7, N1, N3, N7, N41 (2.496 GHz˜2.69 GHz), N75 (1.43 GHz 1.517 GHz), and the like. This is beneficial to meeting band allocation requirements of different operators. In comparison to the antenna assembly 100 in FIG. 3, the antenna assembly in FIG. 4 further achieves high-efficiency coverage for 1.4 GHz˜1.5 GHz, and thus covers bands such as (B32+B3+B1+B7), (B75+B3+B1+B7), (B21+B3+B1+B7), (B3+N41), (B3+B1+N7), and (B3+N1), thereby achieving good performance of EN-DC/CA.

In other embodiments, the antenna assembly 100 may also be applied to a band of 5.925 GHz˜7.125 GHz to support the WiFi-6E band, etc.

In other embodiments, three bands of the four bands (i.e., the fourth band T4, the fifth band T5, the sixth band T6, and the seventh band T7) are consecutive, while the fourth band of the four bands is spaced apart from the three bands that are consecutive. The three bands that are consecutive can meet specific bandwidth requirements, while the band that is inconsecutive with others can meet requirements that the antenna assembly 100 can cover bands with a specific frequency span, for example, the antenna assembly 100 supports both the MHB and the UHB. Alternatively, two bands of the four bands (i.e., the fourth band T4, the fifth band T5, the sixth band T6, and the seventh band T7) are consecutive, while the other two bands of the four bands are consecutive or inconsecutive. Alternatively, the fourth band T4, the fifth band T5, the sixth band T6, and the seventh band T7 are all inconsecutive, so that the bands supported by the antenna assembly 100 may have a specific frequency span.

For example, for a coverage of (B32+B3/N3+B1/N1+B7/N7), B32 is a band of 1.452 GHz˜1.496 GHz, B3/N3 is a band of 1.71 GHz˜1.785 GHz, B1/N1 is a band of 1.92 GHz˜1.98 GHz, and B7/N7 is a band of 2.5 GHz˜2.57 GHz. Therefore, a relatively high efficiency may not be required in a band of 1.5 GHz˜1.7 GHz, and the fourth band T4 and the fifth band T5 may be inconsecutive in the band of 1.5 GHz˜1.7 GHz. In other embodiments, a tuning can be performed to enable the fourth band T4 and the fifth band T5 to support the MHB such as B3/N3+B1/N1, and enable the sixth band T6 and the seventh band T7 to support the UHB such as N78 (3.3 GHz˜3.8 GHz).

Referring to FIG. 18, FIG. 18 illustrates efficiencies of the antenna assembly 100 provided in the disclosure in a full-screen environment. In FIG. 18, a dotted line represents a system radiation efficiency curve of the antenna assembly 100 in FIG. 4, and a solid line represents a system total efficiency curve of the antenna assembly 100 in FIG. 4. In the disclosure, a metal alloy in the middle frame 420 and the display screen 200 are taken as the reference ground GND, and a distance between the radiator 10 of the antenna assembly 100 and the reference ground GND is less than or equal to 0.5 mm. In other words, the antenna assembly 100 has a clearance area of 0.5 mm, which satisfies environmental requirements of the electronic device 1000 such as a current mobile phone. It can be seen from FIG. 18 that the antenna assembly 100 has a high efficiency within 1.43 GHz˜2.69 GHz, even in an extremely small clearance area. For example, the antenna assembly 100 has an efficiency greater than or equal to −5 dB within 1.43 GHz˜2.69 GHz. The efficiency of −5 dB corresponds to a relative bandwidth of over 60%, thereby achieving an ultra-wideband coverage. Due to mutual enhancement among the fourth resonant mode d, the fifth resonant mode e, the sixth resonant mode f and the seventh resonant mode g, the same efficiency can be achieved with a reduced clearance area, thereby facilitating miniaturization of the electronic device 1000.

It can be seen from the above that the antenna assembly 100 provided in the disclosure still has high radiation efficiency in an extremely small clearance area. Thus, when applied to the electronic device 1000 with a relatively small clearance area, the antenna assembly 100 allows the electronic device 1000 to have smaller overall size than other antennas that require a relatively large clearance area to achieve high efficiency.

The fourth resonant mode d, the fifth resonant mode e, the sixth resonant mode f and the seventh resonant mode g are described below from a perspective of the current distribution.

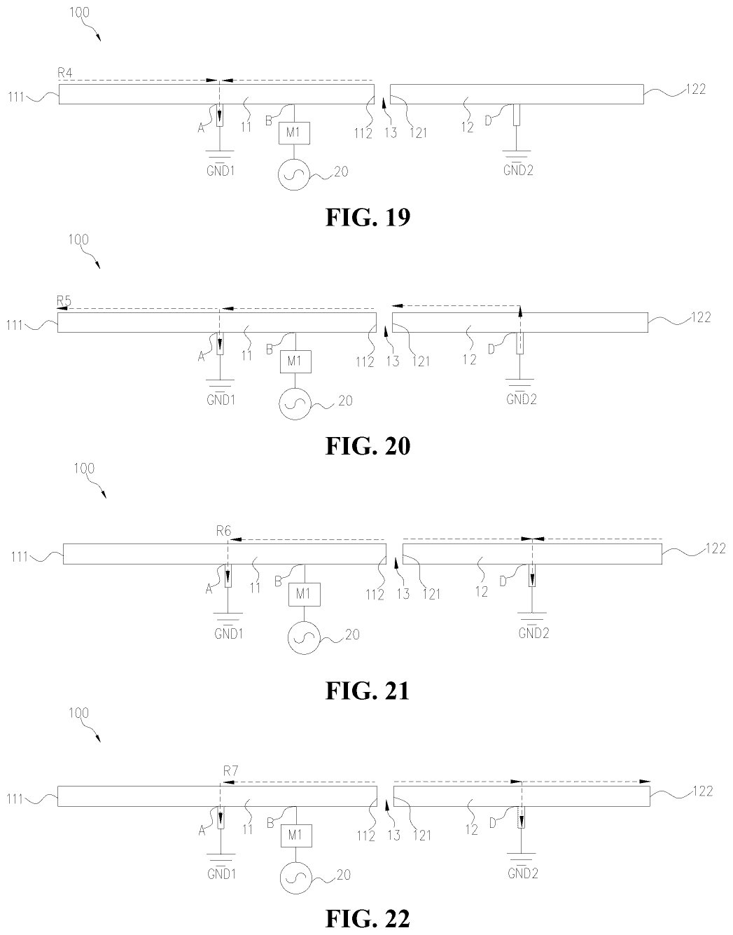

Referring to FIGS. 6 and 19, a fourth resonant current R4 in the fourth resonant mode d is at least or mainly distributed between the first free end 111 and the first coupling end 112. A direction in which the fourth resonant current R4 flows between the first free end 111 and the first ground point A is opposite to a direction in which the fourth resonant current R4 flows between the first ground point A and the first coupling end 112. Specifically, part of the fourth resonant current R4 flows from the first free end 111 to the first ground point A, and then flows from the first ground point A to the ground. Another part of the fourth resonant current R4 flows from the first coupling end 112 to the first ground point A, and then flows from the first ground point A to the ground. Alternatively, part of the fourth resonant current R4 flows from the first ground point A to the first coupling end 112, and another part of the fourth resonant current R4 flows from the first ground point A to the first free end 111. It is noted that, a small part of the fourth resonant current R4 may flows to the second sub-radiator 12, but has an extremely low current density. The first sub-radiator 11 is a T-shaped antenna. Currents at two sides of the first ground point A of the first sub-radiator 11 flow in opposite directions, and thus the T-shaped antenna has a monopole characteristic. The monopole characteristic enables the first sub-radiator 11 to excite a large amount of ground (i.e., a reference ground) current. This enhances radiation efficiency, thereby leading to generation of the fourth resonant mode d at the fourth frequency f4.

Referring to FIGS. 6 and 20, a fifth resonant current R5 in the fifth resonant mode e is at least or mainly distributed between the first free end 111 and the first coupling end 112 and between the second coupling end 121 and the second ground point D. A direction in which the fifth resonant current R5 flows between the first free end 111 and the first ground point A, a direction in which the fifth resonant current R5 flows between the first ground point A and the first coupling end 112, and a direction in which the fifth resonant current R5 flows between the second coupling end 121 and the second ground point D are the same with each other. Specifically, a first part of the fifth resonant current R5 flows from the second reference ground GND2 to the second ground point D, then flows from the second ground point D to the second coupling end 121, then flows from the second coupling end 121 to the first coupling end 112 through the coupling gap 13, then flows from the first coupling end 112 to the first ground point A, and then flows from the first ground point A to the first reference ground GND1; another part of the fifth resonant current R5 flows from the first ground point A to the first free end 111. Alternatively, a first part of the fifth resonant current R5 flows from the first reference ground GND1 to the first ground point A, then flows from the first ground point A to the first coupling end 112 along the first sub-radiator 11, then flows from the first coupling end 112 to the second coupling end 121 through the coupling gap 13, then flows from the second coupling end 121 to the second ground point D, and then flows from the second ground point D to the second reference ground GND2; another part of the fifth resonant current R5 flows from the first ground point A to the first free end 111. It is noted that, the fifth resonant current R5 is mainly distributed on the first sub-radiator 11 and part of the second sub-radiator 12 between the second ground point D and one end of the second sub-radiator 12 close to the first sub-radiator 11. Additionally, a small part of the fifth resonant current R5 may flow to part of the second sub-radiator 12 between the second ground point D and one end of the second sub-radiator 12 away from the first sub-radiator 11, but has an extremely low current density. The first sub-radiator 11 is a T-shaped antenna. Currents at two sides of the first ground point A of the first sub-radiator 11 flow in the same direction, and thus the T-shaped antenna has a dipole characteristic. The dipole characteristic enables the first sub-radiator 11 to excite high radiation efficiency, leading to a generation of the fifth resonant mode e at the fifth frequency f5.

Referring to FIGS. 6 and 21, a sixth resonant current R6 in the sixth resonant mode f is mainly distributed between the first ground point A and the first coupling end 112 and between the second coupling end 121 and the second free end 122. A direction in which the sixth resonant current R6 flows between the first ground point A and the first coupling end 112 is opposite to a direction in which the sixth resonant current R6 flows between the second coupling end 121 and the second ground point D. A direction in which the sixth resonant current R6 flows between the second ground point D and the second free end 122 is opposite to the direction in which the sixth resonant current R6 flows between the second coupling end 121 and the second ground point D. Specifically, a first part of the sixth resonant current R6 flows from the first coupling end 112 to the first ground point A, and then flows from the first ground point A to the ground; a second part of the sixth resonant current R6 flows from the second coupling end 121 to the second ground point D, and then flows from the second ground point D to the ground; and a third part of the sixth resonant current R6 flows from second free end 122 to the second ground point D, and then flows from the second ground point D to the ground. Alternatively, a first part of the sixth resonant current R6 flows from the first reference ground GND1 to the first ground point A, and then flows from the first ground point A to the first coupling end 112; a second part of the sixth resonant current R6 flows from the second reference ground GND2 to the second ground point D, and then flows from the second ground point D to the second coupling end 121; and a third part of the sixth resonant current R6 flows from the second ground point D to the second free end 122. The second sub-radiator 12 is a T-shaped antenna. Currents at two sides of the second ground point D of the second sub-radiator 12 flow in opposite directions, and thus the T-shaped antenna has a monopole characteristic. The monopole characteristic enables the second sub-radiator 12 to excite a large amount of ground (i.e., a reference ground) current. This enhances radiation efficiency, thereby leading to generation of the sixth resonant mode f at the sixth frequency f6.

Referring to FIGS. 6 and 22, a seventh resonant current R7 in the seventh resonant mode g is mainly distributed between the first ground point A and the first coupling end 112 and between the second coupling end 121 and the second free end 122. A direction in which the seventh resonant current R7 flows between the first ground point A and the first coupling end 112 is opposite to a direction in which the seventh resonant current R7 flows between the second coupling end 121 and the second ground point D, and a direction in which the seventh resonant current R7 flows between the second ground point D and the second free end 122 is the same as the direction in which the seventh resonant current R7 flows between the second coupling end 121 and the second ground point D. Specifically, a first part of the seventh resonant current R7 flows from the first coupling end 112 to the first ground point A, and then flows from the first ground point A to the ground; a second part of the seventh resonant current R7 flows from the second coupling end 121 to the second ground point D, and then flows from the second ground point D to the ground; and a third part of the seventh resonant current R7 flows from the second ground point D to the second free end 122. Alternatively, a first part of the seventh resonant current R7 flows from the first reference ground GND1 to the first ground point A, and then flows from the first ground point A to the first coupling end 112; a second part of the seventh resonant current R7 flows from the second reference ground GND2 to the second ground point D, and then flows from the second ground point D to the second coupling end 121; and a third part of the seventh resonant current R7 flows from the second free end 122 to the second ground point D. The second sub-radiator 12 is a T-shaped antenna. Current at two sides of the second ground point D of the second sub-radiator 12 flow in the same direction, and thus the T-shaped antenna has a dipole characteristic. The dipole characteristic allows high radiation efficiency, leading to generation of the seventh resonant mode g at the seventh frequency f7.

It is noted that, in view of resonant current distributions of the fourth resonant mode d, the fifth resonant mode e, the sixth resonant mode f and the seventh resonant mode g, part of the resonant current corresponding to the fourth resonant mode d, part of the resonant current corresponding to the fifth resonant mode e, part of the resonant current corresponding to the sixth resonant mode f and part of the resonant current corresponding to the seventh resonant mode g have the same direction of flow (e.g., a direction from the first coupling end 112 to the first ground point A). As such, mutual enhancement among the fourth resonant mode d, the fifth resonant mode e, the sixth resonant mode f and the seventh resonant mode g may be achieved, thereby widening the width of the antenna assembly 100.

Based on resonant current modes described above, the length of the first sub-radiator 11 and the length of the second sub-radiator 12 under each resonant current distribution can be set in the following embodiments, so that each resonant current can excite a resonant mode.

The generation of the fourth resonant mode d, the fifth resonant mode e, the sixth resonant mode f and the seventh resonant mode g are described with reference to a wavelength mode corresponding to the fourth resonant frequency f4, a wavelength mode corresponding to the fifth resonant frequency f5, a wavelength mode corresponding to the sixth resonant frequency f6, and a wavelength mode corresponding to the seventh resonant frequency f7.

Referring to FIGS. 6 and 19, a wavelength corresponding to the center frequency of the fourth resonant mode d is a fourth wavelength. Optionally, the fourth resonant mode d is a (⅛˜¼) wavelength mode in which part of the first sub-radiator 11 between the first ground point A and the first coupling end 112 operates. Specifically, a length of the part of the first sub-radiator 11 between the first ground point A and the first coupling end 112 is about (⅛˜¼) times the fourth wavelength. In other words, the length of the part of the first sub-radiator 11 between the first ground point A and the first coupling end 112 is about (⅛˜¼) times a wavelength corresponding to the fourth frequency f4. In a case where a matching circuit for adjusting a frequency shift is absent from a flow path of the fourth resonant current R4, the length of the part of the first sub-radiator 11 between the first ground point A and the first coupling end 112 is about (¼) times the wavelength corresponding to the fourth frequency f4, so that the part of the first sub-radiator 11 between the first ground point A and the first coupling end 112 can achieve high transmission and reception efficiency at the fourth frequency f4 and in turn resonate at the fourth frequency f4, thereby generating the fourth resonant mode d. In a case where a matching circuit, which is grounded and capacitive when the matching circuit operates in the fourth band T4, is disposed on the flow path of the fourth resonant current R4, capacitive loading may enable the resonant frequency to shift towards a low frequency, so that the length of the part of the first sub-radiator 11 between the first ground point A and the first coupling end 112 that allows generation of the resonance at the fourth frequency f4 may be shortened, for example, reduced to (⅛) times the wavelength corresponding to the fourth frequency f4, thereby further reducing the size of the first sub-radiator 11. In addition, a capacitive circuit connected to the ground may also be disposed in the first matching circuit M1, and capacitive loading is performed in a region where the fourth resonant current R4 flows, so that the resonant frequency may shift towards a low frequency, and therefore, the length of the first sub-radiator 11 that allows generation of resonance at the fourth frequency f4 may be shortened, for example, reduced to (⅛) times the wavelength corresponding to the fourth frequency f4.

Referring to FIGS. 6 and 20, a wavelength corresponding to the center frequency of the fifth resonant mode e is a fifth wavelength. Optionally, the fifth resonant mode e is a (½) wavelength mode in which the first sub-radiator 11 operates. Specifically, the length of the first sub-radiator 11 is about (½) times the fifth wavelength. In other words, the length of the first sub-radiator 11 is about (½) times a wavelength corresponding to the fifth frequency f5, so that the first sub-radiator 11 can have high transmission and reception efficiency at the fifth frequency f5 and in turn resonate at the fifth frequency f5, thereby generating the fifth resonant mode e. Further, by providing a capacitive matching circuit that is grounded on a distribution path of the fifth resonant current R5, the length of the first sub-radiator 11 can be further shortened.

Referring to FIGS. 6 and 21, a wavelength corresponding to the center frequency of the sixth resonant mode f is a sixth wavelength. The sixth resonant mode f is a (⅛˜¼) wavelength mode in which part of the second sub-radiator 12 between the second coupling end 121 and the second ground point D operates. Specifically, a length of the part of the second sub-radiator 12 between the second coupling end 121 and the second ground point D is about (⅛˜¼) times the sixth wavelength. In other words, the length of the part of the second sub-radiator 12 between the second coupling end 121 and the second ground point D is about (⅛˜¼) times a wavelength corresponding to the sixth frequency f6. In a case where a matching circuit for adjusting a frequency shift is absent from a flow path of the sixth resonant current R6, the length of the part of the second sub-radiator 12 between the second coupling end 121 and the second ground point D is about (¼) times the wavelength corresponding to the sixth frequency f6, so that the part of the second sub-radiator 12 between the second coupling end 121 and the second ground point D can achieve high transmission and reception efficiency at the sixth frequency f6 and in turn resonate at the sixth frequency f6, thereby generating the sixth resonant mode f. In a case where a matching circuit, which is grounded and capacitive when the matching circuit operates in the sixth band T6, is disposed on the flow path of the sixth resonant current R6, capacitive loading may enable the resonant frequency to shift towards a low frequency, so that the length of the part of the second sub-radiator 12 between the second coupling end 121 and the second ground point D that allows generation of the resonance at the sixth frequency f6 is shortened, for example, reduced to (⅛) times the wavelength corresponding to the sixth frequency f6, thereby further reducing the size of the second sub-radiator 12. In addition, a capacitive circuit connected to the ground may also be disposed in the first matching circuit M1, and capacitive loading is performed in a region where the sixth resonant current R6 flows, so that the resonant frequency may shift towards a low frequency, and therefore, a length of the part of the second sub-radiator 12 between the second coupling end 121 and the second ground point D that allows generation of the resonance at the sixth frequency f6 can be shortened to less than (⅛) times the wavelength corresponding to the sixth frequency f6.

Referring to FIGS. 6 and 22, a wavelength corresponding to the center frequency of the seventh resonant mode g is a seventh wavelength. The seventh resonant mode g is a (½) wavelength mode in which the second sub-radiator 12 operates. The length of the second sub-radiator 12 is about (½) times the seventh wavelength. The length of the second sub-radiator 12 is about (½) times the seventh wavelength, thereby allowing the antenna assembly 100 to achieve relatively high signal transmission and reception efficiency at the seventh frequency f7. Further, by providing a capacitive matching circuit that is grounded on a distribution path of the seventh resonant current R7, the length of the second sub-radiator 12 can be further shortened.

It can be seen from the antenna assembly 100 in FIG. 3 and the antenna assembly 100 in FIG. 4 that, a distribution of the first resonant current R1 is partially the same as a distribution of the fifth resonant current R5, a distribution of the second resonant current R2 is the same as a distribution of the sixth resonant current R6, and a distribution of the third resonant current R3 is the same as a distribution of the seventh resonant current R7. In other words, the antenna assembly 100 in FIG. 3 and the antenna assembly 100 in FIG. 4 have the following current distributions. A first current is distributed between the first ground point A and the second ground point D. Specifically, the first current flows from the first reference ground GND1 to the first ground point A, then flows from the first ground point A to the first coupling end 112, then flows from the first coupling end 112 to the second coupling end 121 through the coupling gap 13, then flows from the second coupling end 121 to the second ground point D, and then flows from the second ground point D to the second reference ground GND2. Alternatively, the first current flows from the second reference ground GND2 to the second ground point D, then flows from the second ground point D to the second coupling end 121, then flows from the second coupling end 121 to the first coupling end 112 through the coupling gap 13, then flows from the first coupling end 112 to the first ground point A, and then flows from the first ground point A to the first reference ground GND1.

A second current is distributed between the first ground point A and the first coupling end 112 and between the second coupling end 121 and the second free end 122. The direction in which the sixth resonant current R6 flows between the first ground point A and the first coupling end 112 is opposite to the direction in which the sixth resonant current R6 flows between the second coupling end 121 and the second ground point D. The second current is distributed to support both the antenna assembly 100 in FIG. 3 and the antenna assembly 100 in FIG. 4 to generate a first sub-resonant mode. The length of the part of the second sub-radiator 12 between the second coupling end 121 and the second ground point D can correspond to (¼) times a wavelength corresponding to a center frequency of the first sub-resonant mode. Furthermore, by providing a capacitive matching circuit that is grounded on a second current distribution path, the length of the part of the second sub-radiator 12 between the second coupling end 121 and the second ground point D can be shortened to be (⅛) times a wavelength corresponding to the center frequency of the first sub-resonant mode.

A third current is distributed between the first ground point A and the first coupling end 112 and between the second coupling end 121 and the second free end 122. The direction in which the seventh resonant current R7 flows between the first ground point A and the first coupling end 112 is opposite to the direction in which the seventh resonant current R7 flows between the second coupling end 121 and the second ground point D, and the direction in which the seventh resonant current R7 flows between the second ground point D and the second free end 122 is the same as the direction in which the seventh resonant current R7 flows between the second coupling end 121 and the second ground point D. The third current is distributed to support both the antenna assembly 100 in FIG. 3 and the antenna assembly 100 in FIG. 4 to generate a second sub-resonant mode. The length of the second sub-radiator 12 is (½) times a wavelength corresponding to a central frequency of the second sub-resonant mode. Furthermore, by providing a capacitive matching circuit that is grounded on a third current distribution path, the length of the second sub-radiator 12 can be further shortened.

Furthermore, by adjusting the length of the first sub-radiator 11, the length of the second sub-radiator 12, the position of the first ground point A, the position of the feed point B, and the position of the second ground point D, the fourth frequency f4, the fifth frequency f5, the sixth frequency f6, and the seventh frequency f7 may be shifted towards each other, so that the fourth band T4, the fifth band T5, the sixth band T6, and the seventh band T7 are consecutive. This can support a relatively wide bandwidth, and cover a band required, thereby improving the throughput of the antenna assembly 100 and the Internet access rate of the electronic device 1000.

A matching circuit is described hereinafter. The matching circuit is grounded and disposed on a path to adjust a frequency shift of a corresponding resonant mode. This can shorten the length of the first sub-radiator 11 and the length of the second sub-radiator 12, thereby further shortening an overall stack size of the antenna assembly 100.

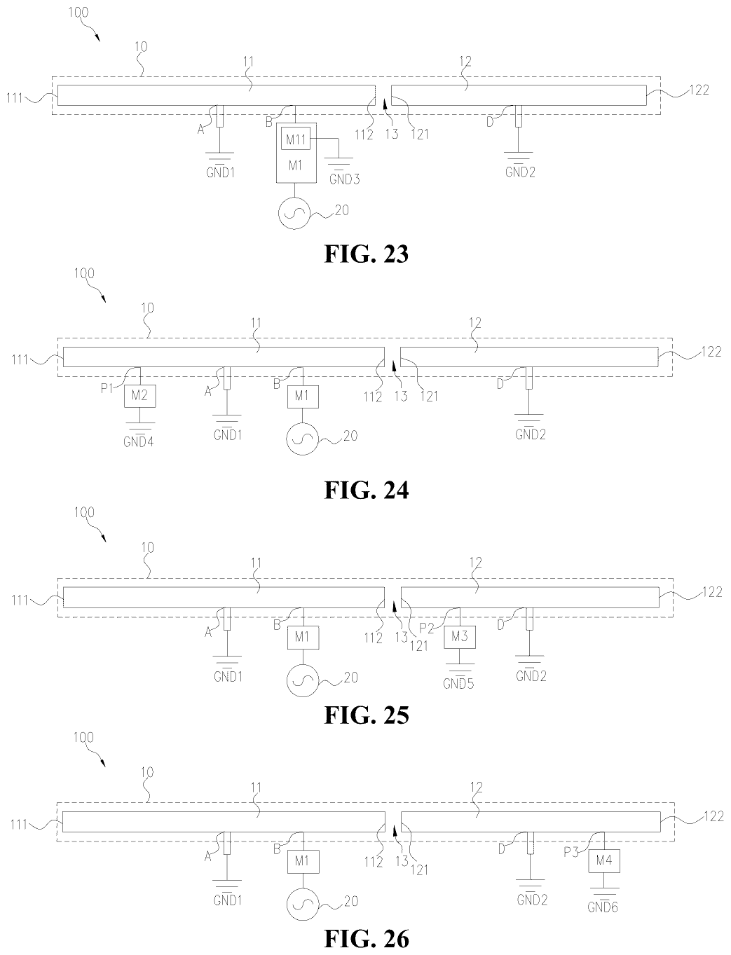

Referring to FIG. 23, the first matching circuit M1 includes a first sub-circuit M11. The first sub-circuit M11 has one end electrically connected to the feed point B and another end electrically connected to a third reference ground GND3. The first sub-circuit M11 is configured to adjust a frequency shift of a resonant mode by adjusting a resonant current flowing through the first sub-circuit M11. The first sub-circuit M11 is capacitive when the first sub-circuit M11 operates in a band supported by the fourth resonant mode d (i.e., the fourth band T4), a band supported by the fifth resonant mode e (i.e., the fifth band T5), a band supported by the sixth resonant mode f (i.e., the sixth band T6), and a band supported by the seventh resonant mode g (i.e., the seventh band T7). The first sub-circuit M11 can shift the center frequency of the fourth resonant mode d, the center frequency of the fifth resonant mode e, the center frequency of the sixth resonant mode f and the center frequency of the seventh resonant mode g towards a low frequency. The first sub-circuit M11 can be regarded as a segment with an effective electrical length that is connected to the part of the first sub-radiator 11 between the first ground point A and the first coupling end 112. Hence, in a case where a center frequency of a resonance is required to remain unchanged, the first sub-circuit M11 is provided to allow a shortened actual length of the part of the first sub-radiator 11 between the first ground point A and the first coupling end 112. This can achieve miniaturization of the first sub-radiator 11, and the length of the part of the first sub-radiator 11 between the first ground point A and the first coupling end 112 may be shortened to (⅛) times the wavelength corresponding to the fourth frequency f4.

Optionally, the first sub-circuit M11 includes, but is not limited to, a capacitor, a circuit including a capacitor, an inductor, and a resistor that are connected in series, or a circuit including a capacitor, an inductor, and a resistor that are connected in parallel, and the like.

Referring to FIG. 24, the first sub-radiator 11 further has a first frequency-tuning point P1 positioned between the first free end 111 and the first ground point A. The antenna assembly 100 further includes a second matching circuit M2. The second matching circuit M2 includes one end electrically connected to the first frequency-tuning point P1 and another end electrically connected to a fourth reference ground GND4.

The second matching circuit M2 is capacitive when the second matching circuit M2 operates in the band supported by the fourth resonant mode d (i.e., the fourth band T4) and the band supported by the fifth resonant mode e (i.e., the fifth band T5), and thus can shift the center frequency of the fourth resonant mode d and the center frequency of the fifth resonant mode e toward a low frequency. Hence, in a case where a center frequency of a resonance is required to remain unchanged, an actual length of part of the first sub-radiator 11 between the first free end 111 and the first ground point A can be relatively reduced. The second matching circuit M2 is provided to allow a shortened actual length of part of the first sub-radiator 11 between the first ground point A and the first coupling end 112. This can achieve miniaturization of the first sub-radiator 11, and the length of the part of the first sub-radiator 11 between the first ground point A and the first coupling end 112 may be shortened to (⅛) times the wavelength corresponding to the fourth frequency f4.

The second matching circuit M2 may include adjustable components such as a variable capacitor, and multiple selection branches formed by a switch(s), a capacitor(s), an inductor(s), and a resistor(s). These adjustable components are configured to adjust positions of the fourth resonant mode d and the fifth resonant mode e. A change in a position of a mode may enhance the performance of a single band, and can also better meet band combinations for EN-DC/CA.

Referring to FIG. 25, the second sub-radiator 12 further has a second frequency-tuning point P2 positioned between the second coupling end 121 and the second ground point D. The antenna assembly 100 further includes a third matching circuit M3. The third matching circuit M3 has one end electrically connected to the second frequency-tuning point P2 and another end electrically connected to the fifth reference ground GND5. The third matching circuit M3 is capacitive when the third matching circuit M3 operates in the band supported by the fifth resonant mode e, the band supported by the sixth resonant mode f, and the band supported by the seventh resonant mode g, and thus can shift the center frequency of the fifth resonant mode e, the center frequency of the sixth resonant mode f, and the center frequency of the seventh resonant mode g towards a low frequency. Hence, in a case where a center frequency of a resonance is required to remain unchanged, an actual length of part of the second sub-radiator 12 between the second coupling end 121 and the second ground point D may be relatively reduced. The third matching circuit M3 can be regarded as a segment with an effective electrical length that is connected to the part of the second sub-radiator 12 between the second coupling end 121 and the second ground point D. Hence, in a case where a center frequency of a resonance is required to remain unchanged, the third matching circuit M3 is provided to allow a shortened actual length of the part of the second sub-radiator 12 between the second coupling end 121 and the second ground point D. This can achieve miniaturization of the second sub-radiator 12, and the length of the part of the second sub-radiator 12 between the second coupling end 121 and the second ground point D may be shortened to (⅛) times the wavelength corresponding to the sixth frequency f6.

The third matching circuit M3 may include adjustable components such as a variable capacitor, and multiple selection branches formed by a switch(s), a capacitor(s), an inductor(s), and a resistor(s). These adjustable components are configured to adjust positions of the fifth resonant mode e, the sixth resonant mode f, and the seventh resonant mode g. A change in a position of a mode may enhance the performance of a single band, and can also better meet band combinations for EN-DC/CA.

Referring to FIG. 26, the second sub-radiator 12 further has a third frequency-tuning point P3 positioned between the second ground point D and the second free end 122. The antenna assembly 100 further includes a fourth matching circuit M4. The fourth matching circuit M4 has one end electrically connected to the third frequency-tuning point P3 and another end electrically connected to the sixth reference ground GND6. The fourth matching circuit M4 is capacitive when the fourth matching circuit M4 operates in the band supported by the sixth resonant mode f and the band supported by the seventh resonant mode g, and thus can shift the center frequency of the sixth resonant mode f and the center frequency of the seventh resonant mode g towards a low frequency. Hence, in a case where a center frequency of a resonance is required to remain unchanged, an actual length of the part of the second sub-radiator 12 between the second coupling end 121 and the second ground point D may be relatively reduced. This can achieve miniaturization of the second sub-radiator 12, and the length of the part of the second sub-radiator 12 between the second coupling end 121 and the second ground point D may be shortened to (⅛) times the wavelength corresponding to the sixth frequency f6.

The fourth matching circuit M4 may include adjustable components such as a variable capacitor, and multiple selection branches formed by a switch(s), a capacitor(s), an inductor(s), and a resistor(s). These adjustable components are configured to adjust a position of a resonant mode. A change in a position of a mode may enhance the performance of a single band, and can also better meet band combinations for EN-DC/CA.

It can be understood that, during design of the antenna assembly 100, any one, two, or three of the first sub-circuit M11 of the first matching circuit M1, the second matching circuit M2, the third matching circuit M3, and the fourth matching circuit M4 may be selected and arranged at corresponding positions. Alternatively, all the first sub-circuit M11 of the first matching circuit M1, the second matching circuit M2, the third matching circuit M3, and the fourth matching circuit M4 may be arranged at corresponding positions, respectively. This can further reduce a stack size of the radiator 10.

The first sub-circuit M11, the second matching circuit M2, and the third matching circuit M3 in the embodiment can also be applied to the antenna assembly 100 in FIG. 3, which will not be repeated herein.

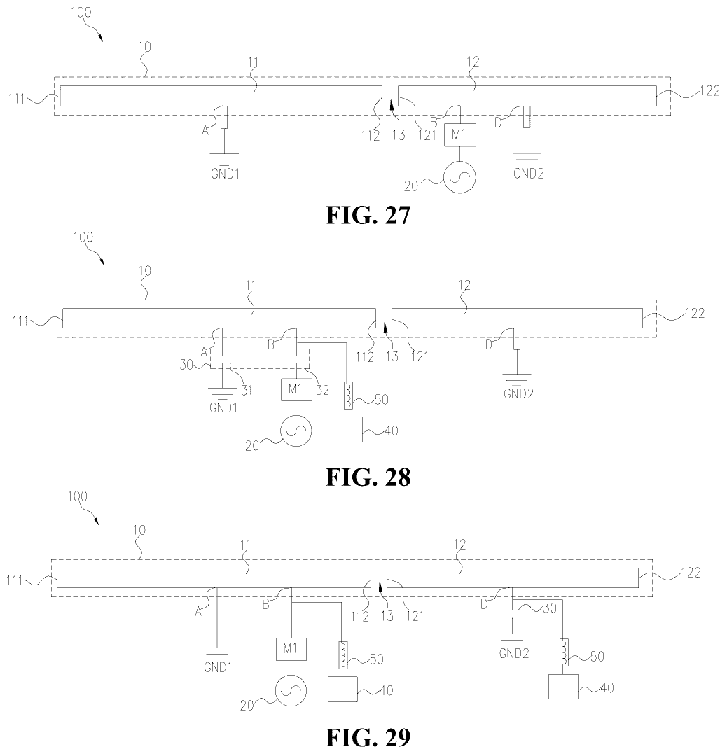

The antenna assembly 100 in FIG. 27 is the same as the antenna assembly 100 in FIG. 4, except that in the antenna assembly in FIG. 27, the feed point B is positioned between the second coupling end 121 and the second ground point D. The antenna assembly 100 in the embodiment can form a double T-shaped radiator, and a current distribution of a monopole mode and a current distribution of a dipole mode can be generated on each T-shaped radiator, so that four resonant modes can be generated, thereby achieving a wide bandwidth or supporting more bands. For the current distributions, the four resonant modes, a wavelength mode corresponding to each resonant mode, and adjusting the length of the radiator by adjusting the frequency shift through the matching circuit in this embodiment, reference may be made to the antenna assembly 100 in FIG. 4, and details are not described herein again.

The function of the antenna assembly 100 provided in any one of the above embodiments will be further described below with reference to the accompanying drawings. For example, the antenna assembly 100 can support both detection on approach of a subject to-be-detected and antenna signal transmission/reception. The subject to-be-detected includes, but is not limited to, the human head, human hands, and the like. It can be understood that the radiator 10 is made of a conductive material. The radiator 10 can also serve as both an electrode for detecting approach signals and a signal transceiver port of an antenna. The antenna assembly 100 provided in the disclosure integrates dual functions of electromagnetic wave signal transmission/reception and approach sensing, and has a compact size. When the antenna assembly 100 is applied to the electronic device 1000, it ensures that the electronic device 1000 not only has a communication function and an approach detection function, but also remains compact in overall size.

Specifically, the antenna assembly 100 further includes a DC-block assembly 30, a filter assembly 50, a detection assembly 40, and a controller 202.

A connection between the DC-block assembly 30 and the filter assembly 50 will be exemplarily described hereinafter with reference to the antenna assembly 100 in FIG. 4.

FIG. 28 illustrates a first connection between the DC-block assembly 30 and the filter assembly 50. The DC-block assembly 30 is electrically connected between the feed point B of the first sub-radiator 11 and the signal source 20 (further, the DC-block assembly 30 is electrically connected between the feed point B and the first matching circuit M1) and between the first ground point A of the first sub-radiator 11 and the first reference ground GND1. The DC-block assembly 30 is configured to block a direct current from the first reference ground GND1, a direct current generated by the signal source 20, and a direct current generated by the first matching circuit M1, and to block RF signals transmitted/received by the radiator 10 (the RF signals include an RF signal between the radiator 10 and the ground GND, and an RF signal between the radiator 10 and the first matching circuit M1). This can support a human body detection function, and improve an accuracy of detection on approach of a human body to the antenna assembly 100.

Specifically, referring to FIG. 28, the DC-block assembly 30 includes a first sub-isolator 31 and a second sub-isolator 32. The first sub-isolator 31 is electrically connected between the first ground point A and the first reference ground GND1. The second sub-isolator 32 is electrically connected between the feed point B and the first matching circuit M1. By setting the DC-block assembly 30, an induction signal generated during approach of the subject to-be-detected to the radiator 10 will not affect the signal transmission/reception of the antenna assembly 100. Specifically, both the first sub-isolator 31 and the second sub-isolator 32 are capacitive components. For example, each of the first sub-isolator 31 and the second sub-isolator 32 includes a capacitor. Further, each of the first sub-isolator 31 and the second sub-isolator 32 is a capacitor. The first sub-isolator 31 and the second sub-isolator 32 have a small impedance to ground for RF signals supported by the antenna assembly 100. For example, each of a value of the first sub-isolator 31 and a value the second sub-isolator 32 includes, but is not limited to, 47 pF, 22 pF, and the like. The first sub-isolator 31 is configured to block a direct current from the first reference ground GND1. The second sub-isolator 32 is configured to block a direct current from the first matching circuit M. This can support a human body detection function, and improve an accuracy of detection on approach of a human body to the antenna assembly 100. In other words, the DC-block assembly 30 enables the first sub-radiator 11 to be in a floating state with respect to a direct current, and can efficiently transmit an RF signal from the first matching circuit M1 to the feed point B and transmit an RF signal from the first ground point A to the first reference ground GND1.

Referring to FIG. 28, one end of the filter assembly 50 is electrically connected to one side of the DC-block assembly 30 close to the first sub-radiator 11 or is electrically connected to any position of the first sub-radiator 11. The filter assembly 50 is configured to block an RF signal transmitted/received by the first sub-radiator 11 and to allow an induction signal generated by the radiator 10 in response to approach of the subject to-be-detected to the first sub-radiator 11 to pass through, so that the RF signal transmitted/received by the first sub-radiator 11 does not affect the accuracy of detecting the induction signal by the detection assembly 40.

Specifically, the filter assembly 50 is electrically connected to a position between the first sub-isolator 31 and the first ground point A. Alternatively, the filter assembly 50 is electrically connected to a position between the second sub-isolator 32 and the feed point B. Alternatively, the filter assembly 50 is electrically connected to any position of the first sub-radiator 11. The filter assembly 50 may include an inductive component. Alternatively, the filter assembly 50 may be an inductive component. For example, the filter assembly 50 is an inductor. The filter assembly 50 has a large impedance (e.g., impedance of 82 nH) to an RF signal supported by the antenna assembly 100.

The DC-block assembly 30 and the filter assembly 50, as described above, allow the induction signal and the RF signal to operate simultaneously without interfering with each other.

The detection assembly 40 is electrically connected to another end of the filter assembly 50. The detection assembly 40 is configured to detect a magnitude of the induction signal generated by the radiator 10. Optionally, the detection assembly 40 is a component configured to detect a current signal, a voltage signal, or an inductance signal, for example, a micro galvanometer, a micro current transformer, a current comparator, a voltage comparator, and the like.

During approach of the human skin to the first sub-radiator 11, the human skin and the first sub-radiator 11 may be equivalent to two electrode plates of a capacitor, respectively. During approach of the human head, the first sub-radiator 11 can detect a variation in a quantity of electric charges caused by the human head. The filter assembly 50 is electrically connected to the first sub-radiator 11. The variation in the quantity of electric charges leads to an induction signal, and the induction signal can be transmitted to the detection assembly 40 through the filter assembly 50. According to a formula for calculating a capacitance, C=εS/4πkd, where d is a distance between a human body (i.e., the head or the hands) and a radiator. Therefore, when the capacitance increases (i.e., when a strength of the induction signal detected by the detection assembly 40 increases), it indicates approach of the human body. When the capacitance decreases (i.e., when the strength of the sense signal detected by the detection assembly 40 decreases), it indicates departure of the human body. The detection assembly 40 is configured to determine whether there is approach of the human head to the first sub-radiator 11 of the antenna assembly 100 by detecting the variation in the quantity of electric charges, thereby intelligently reducing a specific absorption rate of electromagnetic waves in the human head.

Alternatively, at least part of the DC-block assembly 30 may also serve as part of the first matching circuit M1. For example, the second sub-isolator 32 is a capacitor. The second sub-isolator 32 is configured to block an induction signal and to allow an RF signal to pass through. The second sub-isolator 32 may also be configured to serve as part of the first matching circuit M1 to tune impedance matching between the signal source 20 and the feed point B. This can reduce a loss of an RF signal fed into the radiator 10, thereby improving conversion efficiency of signal transmission/reception of the radiator 10. The second sub-isolator 32 may also be configured to adjust a frequency shift of a resonant mode generated by the first sub-radiator 11, among other functions. This achieves the multi-use of a component, thereby reducing the number of components and an occupied space, and improving the integration of the components.

In a case where the antenna assembly 100 is provided with the second matching circuit M2, the third matching circuit M3, and the fourth matching circuit M4, the DC-block assembly 30 may also be disposed between the first frequency-tuning point P1 and the second matching circuit M2, between the second frequency-tuning point P2 and the third matching circuit M3, and between the third frequency-tuning point P3 and the fourth matching circuit M4. This enables the first sub-radiator 11 to be in a floating state relative to the induction signal, thereby preventing the induction signal generated by the first sub-radiator 11 from affecting the RF signal, and facilitating coexistence of antenna signal transmission/reception and generation of the induction signal of the antenna assembly 100. The DC-block assembly 30 for blocking an induction signal at the first frequency-tuning point P1 may serve as part of the second matching circuit M2 to adjust impedance of the second matching circuit M2 and adjust bands supported by the fourth resonant mode d and the fifth resonant mode e. The DC-block assembly 30 for blocking an induction signal at the second frequency-tuning point P2 may server as part of the third matching circuit M3 to adjust impedance of the third matching circuit M3 and adjust the band supported by the fifth resonant mode e, the band supported by the sixth resonant mode f and the band supported by the seventh resonant mode g. The DC-block assembly 30 for blocking an induction signal at the third frequency-tuning point P3 may serve as part of the fourth matching circuit M4 to adjust impedance of the fourth matching circuit M4 and adjust the band supported by the sixth resonant mode f and the band supported by the seventh resonant mode g.

In the antenna assembly 100 and the electronic device 1000 provided in the disclosure, the radiator 10 of the antenna assembly 100 can also be used as a sensing electrode for detecting approach of a subject to-be-detected such as the human body, and the induction signal can be isolated from the RF signal by the DC-block assembly 30 and the filter assembly. This enables the antenna assembly 100 to achieve the dual functions of communication and sensing the subject to-be-detected, thereby enhancing the function of the antenna assembly 100, further improving a utilization rate of components, and reducing an overall size of the electronic device 1000.

FIG. 29 illustrates a second connection between the DC-block assembly 30 and the filter assembly 50. The DC-block assembly 30 is electrically connected between the second ground point D of the second sub-radiator 12 and the second reference ground GND2. For a specific structure of the DC-block assembly 30, isolation of an induction signal, conduction of an RF signal, reference may be made to the first connection between the first DC-block assembly 30 and the filter assembly 50, and details are not repeatedly described herein. One end of the filter assembly 50 is electrically connected to one side of the DC-block assembly 30 close to the second sub-radiator 12 (for example, connected to a position between the DC-block assembly 30 and the second ground point D) or electrically connected to any position of the second sub-radiator 12. The second sub-radiator 12 may serve as a sensing electrode or as a primary sensing electrode. In the embodiment, the second sub-radiator 12 serves as a sensing electrode and is in a floating state relative to a direct current.

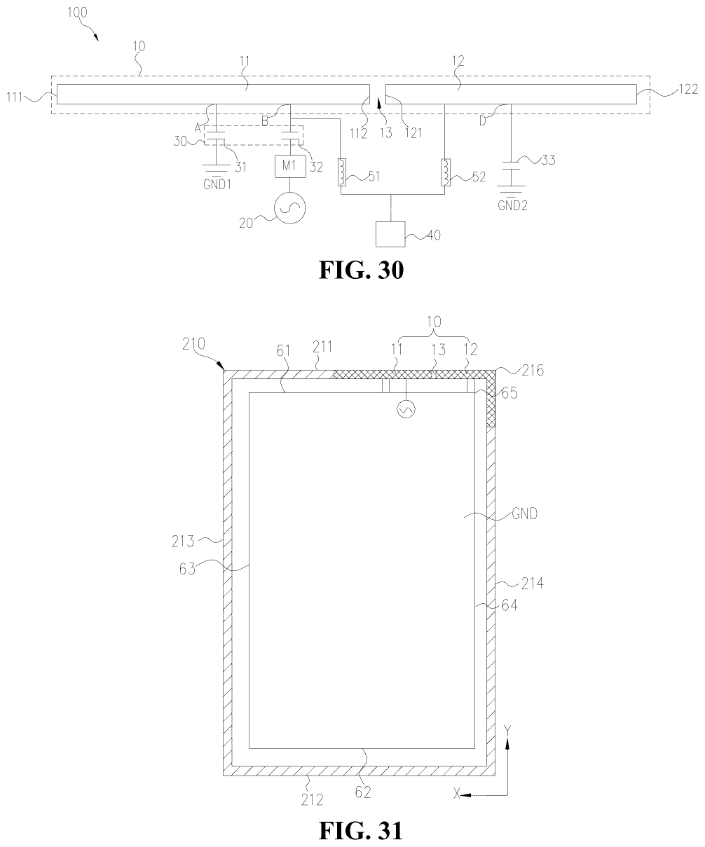

FIG. 30 illustrates a third connection between the DC-block assembly 30 and the filter assembly 50. The DC-block assembly 30 is electrically connected between the feed point B of the first sub-radiator 11 and the first matching circuit M1, between the first ground point A of the first sub-radiator 11 and the first reference ground GND1, and between the second ground point D of the second sub-radiator 12 and the second reference ground GND2, so that both the first sub-radiator 11 and the second sub-radiator 12 can serve as sensing electrodes.

Specifically, the DC-block assembly 30 includes the first sub-isolator 31, the second sub-isolator 32, and a third sub-filter 33. The second sub-isolator 32 is electrically connected between the feed point B and the first matching circuit M1. The first sub-isolator 31 is electrically connected between the first ground point A and the first reference ground GND1. The third sub-filter 33 is electrically connected between the second ground point D and the second reference ground GND2.

The filter assembly 50 includes a first sub-filter 51 and a second sub-filter 52. The first sub-filter 51 is electrically connected to a position between the second sub-isolator 32 and the feed point B, or a position between the first sub-isolator 31 and the first ground point A, or to any position of the first sub-radiator 11. The second sub-filter 52 is electrically connected to a position between the third sub-filter 33 and the second ground point D, or to any position of the second sub-radiator 12.

The detection assembly 40 is electrically connected to the first sub-filter 51 and the second sub-filter 52. Specifically, two channels of the detection assembly 40 are electrically connected to the first sub-filter 51 and the second sub-filter 52, respectively. In the embodiment, both the first sub-radiator 11 and the second sub-radiator 12 serve as detection electrodes for detecting approach of the subject to-be-detected.

During approach of a human body to the first sub-radiator 11, electric charges on the first sub-radiator 11 change, and the detection assembly 40 can directly detect an induction signal through the first sub-filter 51. During approach of a human body to the second sub-radiator 12, electric charges on the second sub-radiator 12 change, and the detection assembly 40 can directly detect an induction signal through the second sub-filter 52. The detection assembly 40 is configured to detect approach of the human body by detecting the induction signals. In this case, the entire radiator 10 can serve as a sensing electrode, so that a sensing area is relatively large, and a utilization rate of the radiator 10 can be improved. This requires only one detection assembly 40, thereby reducing the number of components of the antenna assembly 100 and saving space.

In other embodiments, the detection assembly 40 includes a first sub-detector electrically connected to another end of the first sub-filter 51 and a second sub-detector electrically connected to another end of the second sub-filter 52. In other words, an induction signal generated by the first sub-radiator 11 and an induction signal generated by the second sub-radiator 12 are detected by two mutually independent sub-detectors, respectively. The first sub-detector and the second sub-detector in this embodiment may be used to a case where the first sub-radiator 11 and the second sub-radiator 12 are respectively mounted to different sides of the electronic device 1000, so that approach of the human body from different sides of the electronic device 1000 can be detected through the radiator 10 of one antenna assembly 100, thereby increasing a detection range while occupying a small space.

Specifically, the first sub-isolator 31, the second sub-isolator 32, and the third sub-filter 33 are all isolation capacitors, and the first sub-filter 51 and the second sub-filter 52 are both isolation inductors.

The controller 202 is electrically connected to the detection assembly 40. The detection assembly 40 is configured to receive and convert the induction signal into an electrical signal, and to transfer the electrical signal to the controller 202. The controller 202 is configured to determine a distance between the subject to-be-detected and the radiator 10 according to the magnitude of the induction signal, to determine whether there is approach of a human body to the radiator 10 (e.g., the first sub-radiator 11, the second sub-radiator 12, or both the first sub-radiator 11 and the second sub-radiator 12), and to adjust a power of the signal source 20 in response to approach of the subject to-be-detected to the radiator 10 or departure of the subject to-be-detected from the radiator 10. Specifically, the controller 202 is configured to adjust the power of the signal source 20 (i.e., a power of the antenna assembly 100) according to different scenarios.

For example, during approach of the human head to the radiator 10 of the antenna assembly 100, the controller 202 may lower the power of the antenna assembly 100 to lower the specific absorption rate of electromagnetic waves radiated by the antenna assembly 100. In a case where a standby antenna assembly 100 (i.e., another antenna assembly capable of covering the same band as the antenna assembly 100) is further provided in the electronic device 1000, when the radiator 10 of the antenna assembly 100 is shielded in a radiation direction by the human hand, the controller 202 may turn off the antenna assembly 100 that is shielded and turn on other antenna assemblies 100 that are unshielded. In this way, when the antenna assembly 100 is shielded by the human hand, the communication quality of the electronic device 1000 can be ensured by intelligently switching the antenna assemblies 100. In a case where the standby antenna assembly 100 is absent from the electronic device 1000, the controller 202 may control an increase in power of the antenna assembly 100 to compensate for a decrease in efficiency caused by shielding of the radiator 10 by the hand.

The controller 202 may also be configured to control other applications of the electronic device 1000 according to a detection result of the detection assembly 40. For example, upon detecting that there is approach of the human body to the electronic device 1000 and that the electronic device 1000 is in a call state through the detection assembly 40, the controller 202 may turn off the display screen 300 to reduce power consumption of the electronic device 1000 during a call. Likewise, upon detecting that there is departure of the human body from the electronic device 1000 and that the electronic device 1000 is in a call state, the controller 202 may light up the display screen 300.

It can be understood that, both the antenna assembly 100 in FIG. 3 and the antenna assembly 100 in FIG. 27 may also be provided with the DC-block assembly 30, the filter assembly 50, and the detection assembly 40, and reference can be made to the antenna assembly 100 in FIG. 4, which are not further described herein.

The disclosure does not define a specific position where the radiator 10 of the antenna assembly 100 is mounted to the electronic device 1000.

The electronic device 1000 includes the reference ground GND in the housing 200, a circuit board 500, and the like. The reference ground GND includes, but is not limited to, the metal alloy of the middle plate 410. The first ground point A and the second ground point D are both electrically connected to the reference ground GND. The signal source 20, the first matching circuit M1, the second matching circuit M2, the third matching circuit M3, and the fourth matching circuit M4 are all mounted to the circuit board 500.

The radiator 10 of the antenna assembly 100 is integrated into the housing 200, or is disposed on a surface of the housing 200, or is disposed in a space defined by the housing 200.

Optionally, at least part of the radiator 10 is integrated with the frame 210 of the housing 200. For example, the frame 210 is made of a metal material. Both the first sub-radiator 11 and the second sub-radiator 12 are integrated with the frame 210. The coupling gap 13 between the first sub-radiator 11 and the second sub-radiator 12 is filled with an insulating material. In other embodiments, the radiator 10 may also be integrated with the rear cover 220. In other words, the first sub-radiator 11 and the second sub-radiator 12 are integrated as part of the housing 200.

Optionally, in a case where the radiator 10 is configured to detect approach of a human body and the radiator 10 is integrated with the frame 210, a layer of insulation film may be disposed on a surface of the radiator 10. Because there are charges on the human skin, a capacitor will form between the human skin and the radiator 10, and a signal change caused by approach of the human skin can be detected by the radiator 10.

Optionally, both the first sub-radiator 11 and the second sub-radiator 12 may be formed on a surface (i.e., an inner surface or an outer surface) of the frame 210. Specifically, the first sub-radiator 11 and the second sub-radiator 12 can be formed on an inner surface of the frame 210 through processes which include, but are not limited to, patching, laser direct structuring (LDS), and print direct structuring (PDS). In this embodiment, the frame 210 may be made of a non-conductive material (i.e., the frame 210 is configured to allow electromagnetic wave signals to pass through, or is provided with a radio-wave transparent structure). The radiator 10 may also be disposed on a surface of the rear cover 220.

Optionally, both the first sub-radiator 11 and the second sub-radiator 12 are disposed at a flexible circuit board, a rigid circuit board, or other bearing boards. The first sub-radiator 11 and the second sub-radiator 12 may be integrated with the flexible circuit board, and the flexible circuit board is attached to the inner surface of the middle frame 420 by an adhesive or the like. In this embodiment, the frame 210 may be made of a non-conductive material. The radiator 10 may also be disposed on the inner surface of the rear cover 220.

The above describes a specific structure of the antenna assembly 100 for detecting approach of the subject to-be-detected and transmitting antenna signals, and a position where each component in the antenna assembly 100 is mounted to the electronic device 1000. In the disclosure, there are one or more antenna assemblies 100.

The disclosure does not define a specific side of the electronic device 1000 where the antenna assembly 100 is disposed. The reference ground GND is in a shape of a rectangular plate. The reference ground GND includes multiple side edges connected in sequence. A joint between each two adjacent side edges is a corner. The radiator 10 of at least one antenna assembly 100 is disposed corresponding to two intersected side edges in the multiple side edges and the corner between the two intersected side edges. Alternatively or additionally, the radiator 10 of the at least one antenna assembly 100 is disposed wholly corresponding to one of the multiple side edges. Specifically, the following embodiments are described by using examples.

Referring to FIG. 31, the reference ground GND includes a first side edge 61 and a second side edge 62 that are disposed opposite to each other, and a third side edge 63 and a fourth side edge 64 that are connected between the first side edge 61 and the second side edge 62. A joint between each two adjacent side edges is a corner 65. For reference, in a state in which the electronic device 1000 is held and used by a user in a portrait mode, the first side edge 61 serves as a top edge of the reference ground GND, and the second side edge 62 serves as a bottom edge of the reference ground GND. In an example where the antenna assembly 100 disposed at an upper right corner of the electronic device 1000, optionally, the first sub-radiator 11 may be disposed wholly corresponding to the first side edge 61, part of the second sub-radiator 12 may be disposed corresponding to the first side edge 61, another part of the second sub-radiator 12 may be disposed corresponding to the fourth side edge 64, the first ground point A is electrically connected to the first side edge 61, and the second ground point D is electrically connected to the corner 65 between the first side edge 61 and the fourth side edge 64.

Referring to FIG. 31, the frame 210 includes multiple side frames connected end to end. Each two adjacent side frames in the multiple side frames of the frame 210 are intersected with each other. For example, each two adjacent side frames are transitionally connected through a chamfer. The multiple side frames include a top frame 211 and a bottom frame 212 opposite each other, and a first side frame 213 and a second side frame 214 connected between the top frame 211 and the bottom frame 212. The top frame 211 is an edge away from the ground when the electronic device 1000 is held by an operator and a front side of the electronic device 1000 faces the operator, and the bottom frame 212 is an edge facing the ground. A joint between each two adjacent side frames is a corner 216. The top frame 211 is parallel to and equal to the bottom frame 212. The first side frame 213 is parallel to and equal to the second side frame 214. A length of the first side frame 213 is greater than that of the top frame 211. The top frame 211 is disposed opposite to the first side edge 61, the bottom frame 212 is disposed opposite to the second side edge 62, the first side frame 213 is disposed opposite to the third side edge 63, and the second side frame 214 is disposed opposite to the fourth side edge 64.

The first sub-radiator 11 is integrated with the top frame 211. The second sub-radiator 12 is integrated with part of the top frame 211, the corner 216 between the top frame 211 and the second side frame 214, and part of the second side frame 214.

The positions of the first sub-radiator 11 and the second sub-radiator 12 are interchangeable.

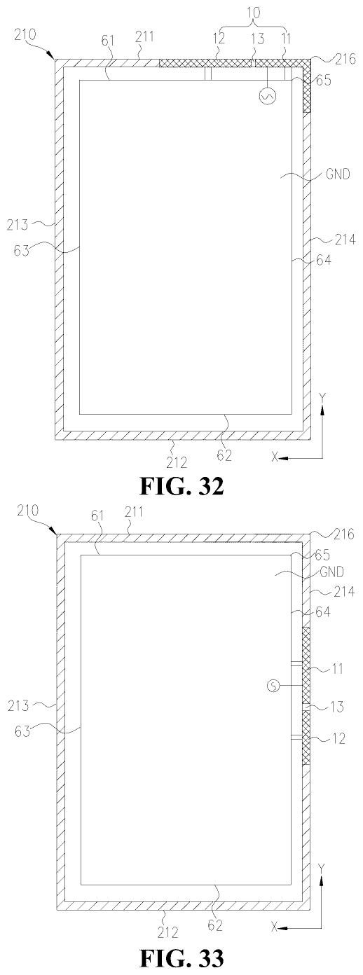

Alternatively, referring to FIG. 32, the second sub-radiator 12 is disposed wholly corresponding to the first side edge 61. Part of the first sub-radiator 11 is disposed corresponding to the first side edge 61, and another part of the first sub-radiator 11 is disposed corresponding to the fourth side edge 64. The second ground point D is electrically connected to the first side edge 61, and the first ground point A is electrically connected to the corner between the first side edge 61 and the fourth side edge 64.

Further, the second sub-radiator 12 is integrated with the top frame 211. The first sub-radiator 11 is integrated with part of the top frame 211, the corner 216 between the top frame 211 and the second side frame 214, and part of the second side frame 214.

In the above embodiments, the antenna assembly 200 is disposed at the corner 65 of the reference ground GND, and the antenna assembly 100 is also disposed at the corner 216 of the electronic device 1000. On the one hand, a good clean environment of the electronic device 1000 is provided, which is beneficial to improving the radiation efficiency of the antenna assembly 100. On the other hand, the antenna assembly 100 is disposed at the corner of the electronic device 1000, which facilitates excitation of a floor current, thereby improving the radiation efficiency.

Referring to FIG. 33, the antenna assembly 100 may be attached wholly to one side of the electronic device 1000. For example, the radiator 10 of the antenna assembly 100 is disposed wholly corresponding to the fourth side edge 64. Furthermore, the radiator 10 is wholly integrated with the second side frame 214.

In other words, the antenna assembly 100 can be positioned anywhere within the electronic device 1000 such that a ground of the antenna assembly 100 can match a ground position within the electronic device 1000.

The above mainly illustrates an arrangement of one antenna assembly 100 in the electronic device 1000. The following will take examples to illustrate an arrangement of multiple antenna assemblies 100 in the electronic device 1000.

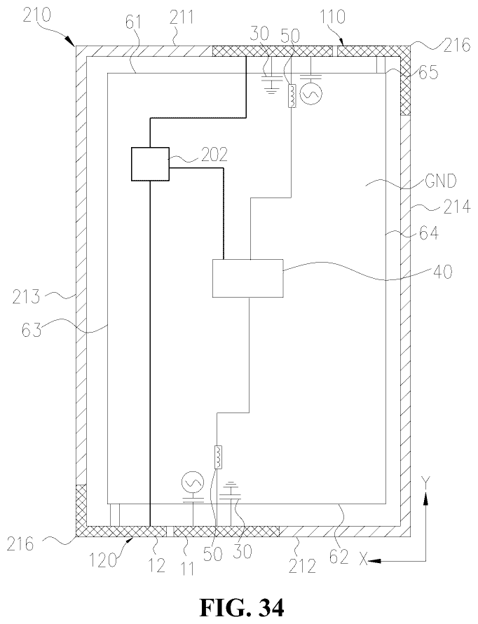

Referring to FIG. 34, the antenna assembly 100 includes a first antenna assembly 110 and a second antenna assembly 120. The first antenna assembly 110 and the second antenna assembly 120 may be the same or different in structure. A band covered by the first antenna assembly 110 may be the same as or different from a band covered by the second antenna assembly 120. In this embodiment, the band covered by the first antenna assembly 110 is at least partially the same as the band covered by the second antenna assembly 120. For example, both the first antenna assembly 110 and the second antenna assembly 120 may cover a band of 1.4 GHz˜2.7 GHz with high efficiency. The first antenna assembly 110 and the second antenna assembly 120 are attached to different sides of the electronic device 1000, respectively, so that the electronic device 1000 can perform a switch between the first antenna assembly 110 and the second antenna assembly 120 when the electronic device 1000 operates in the band of 1.4 GHz˜2.7 GHz.

Alternatively, the first antenna assembly 110 and the second antenna assembly 120 are disposed at or close to two corners 216 that are diagonally disposed. It is understood that, the first antenna assembly 110 being disposed at the corner 216 means that at least part of the radiator 10 of the first antenna assembly 110 is integrated with the corner 216, or printed or laser-molded on a surface of the corner 216, or attached to the surface of the corner 216. The first antenna assembly 110 being close to the corner 216 means that the radiator 10 of the first antenna assembly 110 is disposed in the housing 200 (including the frame 210 and the rear cover 220), or is integrated with the housing 200 and has a small distance (for example, a distance less than or equal to 1 cm, but is not limited thereto) from the corner 216. For the second antenna assembly 120 disposed at or close to the corner 216, reference may be made to the foregoing illustration, and details are not repeated herein.

Specifically, the first antenna assembly 110 is attached to the top frame 211 and close to the corner 216 between the top frame 211 and the second side frame 214. The second antenna assembly 120 is attached to the bottom frame 212 and close to a corner between the bottom frame 212 and the first side frame 213. On the one hand, the coupling gap 13 of the first antenna assembly 110 and the coupling gap 13 of the second antenna assembly 120 are defined on the top frame 211 and the bottom frame 212, respectively, without affecting the first side frame 213 and the second side frame 214, so that a fracturing treatment on a side frame with a larger size can be avoided, thereby improving a structural strength of the frame 210, and reducing an adverse effect on the appearance of the electronic device 1000. On the other hand, the electronic device 1000 is usually held by the user's left hand or right hand to be in a portrait state, the first antenna assembly 110 and the second antenna assembly 120 are attached to the top frame 211 and the bottom frame 212, respectively, and thus will not be shielded by the hand when the electronic device 1000 is held by the user's left hand or right hand to be in the portrait state, thereby achieving high radiation efficiency of the antenna assembly 100 and good communication quality during operation of the antenna assembly 100. Moreover, the first antenna assembly 110 and the second antenna assembly 120 are close to the two corners 216 disposed diagonally, respectively, the first antenna assembly 110 and the second antenna assembly 120 can sense approach of a human body from a top side (a side where the top frame 211 is positioned), a bottom side (a side where the bottom frame 212 is positioned), a left side (a side where the first side frame 213 is positioned), and a right side (a side where the second side frame 214 is positioned) of the electronic device 1000, thereby achieving a larger range of approach sensing with a smaller number of antenna assemblies 100.

In other embodiments, the first antenna assembly 110 and the second antenna assembly 120 are attached to the first side frame 213 and the second side frame 214, respectively, and are close to the corners 216 that are diagonally disposed, respectively.

Optionally, referring to FIG. 34, both the first antenna assembly 110 and the second antenna assembly 120 are configured to detect approach of the subject to-be-detected. Each of the first antenna assembly 110 and the second antenna assembly 120 is provided with the DC-block assembly 30 and the filter assembly 50. For a connection between the DC-block assembly 30 and the filter assembly 50, reference may be made to the foregoing embodiments. The filter assembly 50 of the first antenna assembly 110 and the filter assembly 50 of the second antenna assembly 120 may be electrically connected to different signal channels of the same detection assembly 40, so that the same detection assembly 40 can receive an induction signal generated by the first antenna assembly 110 and an induction signal generated by the second antenna assembly 120 during approach of the subject to-be-detected.

The electronic device 1000 further includes the controller 202. The controller 202 is electrically connected to the first antenna assembly 110, the second antenna assembly 120, and the detection assembly 40. The controller 202 is configured to adjust a power of the first antenna assembly 110 according to a magnitude of the induction signal generated by the first antenna assembly 110 and to adjust a power of the second antenna assembly 120 according to a magnitude of the induction signal generated by the second antenna assembly 120. For example, during approach of the human head to the first antenna assembly 110, it is possible to lower the power of the first antenna assembly 110, or turn off the first antenna assembly 110 and switch to turn on the second antenna assembly 120, thereby lowering a specific absorption rate of electromagnetic wave radiated by the electronic device 1000. Alternatively, when the first antenna assembly 110 is shielded by the human hand, it is possible to improve the power of the first antenna assembly 110 or switch to turn on the second antenna assembly 120, thereby ensuring that the electronic device 1000 has good transmission and reception efficiency in different shielding holding scenarios.

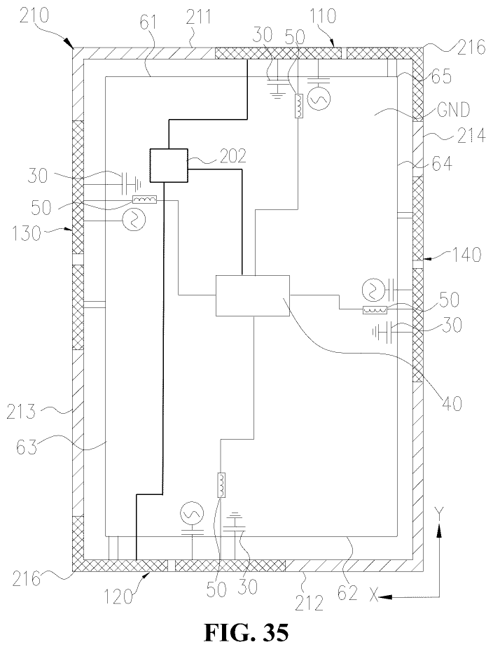

Further, referring to FIG. 35, the at least one antenna assembly 100 further includes a third antenna assembly 130 and a fourth antenna assembly 140. The first antenna assembly 110, the second antenna assembly 120, the third antenna assembly 130, and the fourth antenna assembly 140 may be the same or different in structure.

At least part of the first antenna assembly 110, at least part of the second antenna assembly 120, at least part of the third antenna assembly 130, and at least part of the fourth antenna assembly 140 are arranged at different sides of the reference ground GND. In other words, at least part of the first antenna assembly 110, at least part of the second antenna assembly 120, at least part of the third antenna assembly 130, and at least part of the fourth antenna assembly 140 may be attached to different sides of the electronic device 1000, respectively, so that the first antenna assembly 110, the second antenna assembly 120, the third antenna assembly 130, and the fourth antenna assembly 140 can detect induction signals through different detection assemblies 40, respectively, to recognize from which side the subject to-be-detected approaches the electronic device 1000.

For example, at least part of the first antenna assembly 110 is disposed on the top frame 211, and at least part of the second antenna assembly 120 is disposed on the bottom frame 212. The third antenna assembly 130 and the fourth antenna assembly 140 are disposed on or close to the first side frame 213 and the second side frame 214, respectively.

The third antenna assembly 130 and the fourth antenna assembly 140 can also detect approach of the subject to-be-detected. Each of the third antenna assembly 130 and the fourth antenna assembly 140 is provided with the DC-block assembly 30 and the filter assembly 50. For the DC-block assembly 30 and the filter assembly 50 of the third antenna assembly 130 and the fourth antenna assembly 140, reference may be made to the above embodiments, and will not be described herein.

Optionally, all the first antenna assembly 110, the second antenna assembly 120, the third antenna assembly 130, and the fourth antenna assembly 140 are configured to detect induction signals through the same detection assembly 40 to detect approach of the subject to-be-detected to the electronic device 1000. This eliminates the need for additional detection assembly 40 and reduces a space occupied within the electronic device 1000.

Specifically, the filter assembly 50 of the first antenna assembly 110, the filter assembly 50 of the second antenna assembly 120, the filter assembly 50 of the third antenna assembly 130, and the filter assembly 50 of the fourth antenna assembly 140 are all electrically connected to different signal channels of the same detection assembly 40, respectively, to receive an induction signal generated by the first antenna assembly 110, an induction signal generated by the second antenna assembly 120, an induction signal generated by the third antenna assembly 130, and an induction signal generated by the fourth antenna assembly 140, respectively, during approach of the subject to-be-detected.

The controller 202 is further electrically connected to the third antenna assembly 130 and the fourth antenna assembly 140. The controller 202 is configured to determine a mode which the electronic device 1000 is currently in according to at least one of the magnitude of the inductive signal generated by the first antenna assembly 110, the magnitude of the induction signal generated by the second antenna assembly 120, the magnitude of the induction signal generated by the third antenna assembly 130, and the magnitude of the induction signal generated by the fourth antenna assembly 140, and to adjust at least one of the power of the first antenna assembly 110, the power of the second antenna assembly 120, a power of the third antenna assembly 130, and a power of the fourth antenna assembly 140 according to the mode. The mode includes at least one of a one-hand holding mode, a two-hand holding mode, a carrying mode, and a head approaching mode. The details are described as follows.

Upon detecting that an induction signal received by the detection assembly 40 electrically connected to the filter assembly 50 of the third antenna assembly 130 (hereinafter referred to as an induction signal received by the third antenna assembly 130) is greater than or equal to a preset threshold, and that each of an induction signal received by the first antenna assembly 110, an induction signal received by the second antenna assembly 120, and an induction signal received by the fourth antenna assembly 140 is less than a preset threshold, the controller 202 is configured to determine that there is approach of a human body to the first side frame 213 of the electronic device 1000 and that there is no approach or substantially no approach of a human body to any of the top frame 211, the bottom frame 212, and the second side frame 214. In this case, the electronic device 1000 is in a left-hand holding state.

Upon detecting that the inductive signal received by the fourth antenna assembly 140 is greater than or equal to the preset threshold, and that each of the induction signal received by the first antenna assembly 110, the induction signal received by the second antenna assembly 120, and the induction signal received by the third antenna assembly 130 is less than the preset threshold, the controller 202 is configured to determine that there is approach of a human body to the second side frame 214 of the electronic device 1000 and that there is no approach or substantially no approach of a human body to any of the top frame 211, the bottom frame 212, and the first side frame 213. In this case, the electronic device 1000 is in a right-hand holding state.

Upon detecting that both the induction signal received by the third antenna assembly 130 and the induction signal received by the fourth antenna assembly 140 are greater than or equal to the preset threshold, and that both the induction signal received by the first antenna assembly 110 and the induction signal received by the second antenna assembly 120 are less than the preset threshold, the controller 202 is configured to determine that the electronic device 1000 is in a two-hand holding portrait mode.

Upon detecting that both the induction signal received by the first antenna assembly 110 and the induction signal received by the second antenna assembly 120 are greater than or equal to the preset threshold, and that both the induction signal received by the third antenna assembly 130 and the induction signal received by the fourth antenna assembly 140 are less than the preset threshold, the controller 202 is configured to determine that the electronic device 1000 is in the two-hand holding landscape mode. Furthermore, when the controller 202 determines that the electronic device 1000 is the two-hand holding landscape mode, it can be determined that a demand of the electronic device 1000 for a network access speed increases at that moment, for example, the electronic device 1000 is running a game or video application at that moment, and the power of the antenna assembly 100 can be increased accordingly, thereby improving the network access speed of the electronic device 1000, and enhancing a user's network access experience.

Upon detecting that at least three of the induction signal received by the first antenna assembly 110, the induction signal received by the second antenna assembly 120, the induction signal received by the third antenna assembly 130, and the induction signal received by the fourth antenna assembly 140 are all greater than or equal to the preset threshold, the controller 202 is configured to determine that there is approach of a human body to at least three side frames of the electronic device 1000, and determine that the electronic device 1000 is in a carrying state. Since the electronic device 1000 in the carrying state may have a relatively small demand for high network access speed, the controller 202 may appropriately reduce the power of the antenna assembly 100.

In this embodiment, the electronic device 1000 may further include a functional component (not illustrated). The functional component includes, but is not limited to, at least one of a receiver and a display screen. The controller 202 is electrically connected to the functional component. The controller 202 is configured to determine an operating state of the electronic device 1000 according to a magnitude of the induction signal received by the first antenna assembly 110, a magnitude of the induction signal received by the second antenna assembly 120, a magnitude of the induction signal received by the third antenna assembly 130, a magnitude of the induction signal received by the fourth antenna assembly 140, and an operating state of the functional component.

Optionally, upon detecting that at least one of the induction signal received by the first antenna assembly 110, the induction signal received by the second antenna assembly 120, the induction signal received by the third antenna assembly 130, and the induction signal received by the fourth antenna assembly 140 is greater than or equal to the preset threshold, and that the receiver is in the operating state, the controller 202 is configured to determine that the electronic device 1000 is close to the head of the subject to-be-detected, that is, the human head is close to the electronic device 1000 during a phone call. In this case, the controller 202 can control the power of the antenna assembly 100 to be reduced, to reduce the specific absorption rate of electromagnetic waves in the human head.

Optionally, upon detecting that at least three of the induction signal received by the first antenna assembly 110, the induction signal received by the second antenna assembly 120, the induction signal received by the third antenna assembly 130, and the induction signal received by the fourth antenna assembly 140 are all greater than or equal to the preset threshold and that the display screen 300 is in a non-display state, the controller 202 is configured to determine that the electronic device 1000 may be in the carrying state. The carrying state includes, but is not limited to, a state in which the electronic device 1000 is in a pocket of clothing of the subject to-be-detected, a state in which the electronic device 1000 is worn on the subject to-be-detected via a cord, a wristband, or the like. In this embodiment, the controller 202 may further detect whether the receiver is in the operating state. If the receiver is in a non-operating state, the controller 202 may directly determine that the electronic device 1000 is in a pocket of clothing of the subject to-be-detected. In this case, the controller 202 may reduce the power of the antenna assembly 100 to reduce electromagnetic radiation of the electronic device 1000 to the human body, thereby reducing the specific absorption rate of electromagnetic waves in the human body.

If the receiver is in the operating state, the controller 202 may determine that the electronic device 1000 may be in a pocket of clothing of the subject to-be-detected or in a telephone call. In this case, the controller 202 may reduce the power of the antenna assembly 100 to reduce electromagnetic radiation of the electronic device 1000 to the human body, thereby reducing the specific absorption rate of electromagnetic waves in the human head.

In the above embodiments, the controller 202 is configured to intelligently determine a scenario where the electronic device 1000 is according to at least one of the induction signal received by the first antenna assembly 110, the induction signal received by the second antenna assembly 120, the induction signal received by the third antenna assembly 130, and the induction signal received by the fourth antenna assembly 140, and the operating state of the functional component. Additionally, further in combination with a running state of an application, a current orientation of the electronic device 1000 and an application currently running on the electronic device 1000 may also be determined more accurately, so that the controller 202 can intelligently determine the network access speed requirement of the electronic device 1000. Furthermore, the controller 202 can adjust the power of the first antenna assembly 110, the power of the second antenna assembly 120, the power of the third antenna assembly 130, and the power of the fourth antenna assembly 140 to intelligently match the network access speed requirement of the electronic device 1000, so that the electronic device 1000 has good communication quality in various scenarios.

Optionally, in the case where the first antenna assembly 110, the second antenna assembly 120, the third antenna assembly 130, and the fourth antenna assembly 140 all support the same band, the controller 202 is configured to operate as follows. Upon determining that the electronic device 1000 is held by the left hand, the controller 202 is configured to turn off the third antenna assembly 130 that is shielded and turn on at least one of the first antenna assembly 110, the second antenna assembly 120, and the fourth antenna assembly 140 that are unshielded. Upon determining that the electronic device 1000 is held by the right hand, the controller 202 is configured to turn off the fourth antenna assembly 140 that is shielded and turn on at least one of the first antenna assembly 110, the second antenna assembly 120, and the third antenna assembly 130 that are unshielded. Upon determining that the electronic device 1000 is held in a landscape mode by two hands, the controller 202 is configured to turn off the third antenna assembly 130 and the fourth antenna assembly 140 that are shielded and turn on at least one of the first antenna assembly 110 and the second antenna assembly 120 that are unshielded. Upon determining that the electronic device 1000 is held in the portrait mode by two hands, the controller 202 is configured to turn off the first antenna assembly 110 and the second antenna assembly 120 that are shielded and turn on at least one of the third antenna assembly 130 and the fourth antenna assembly 140 that are unshielded. By intelligently detecting a holding state of the electronic device 1000 and intelligently switching according to the holding state of the electronic device 1000, intelligent switching of the electronic device 1000 in various shielding scenarios can be achieved, so that the electronic device 1000 can support a required band in all the various shielding scenarios, thereby ensuring the communication quality of the electronic device 1000.

The first antenna assembly 110, the second antenna assembly 120, the third antenna assembly 130, and the fourth antenna assembly 140 are all capable of supporting a band which includes, but is not limited to, a band of 1.4 GHz˜2.7 GHz. Furthermore, the first antenna assembly 110, the second antenna assembly 120, the third antenna assembly 130, and the fourth antenna assembly 140 can support the same band. In the four antenna assemblies 100, each antenna assembly 100 can operate is in a duplex mode, and can transmit/receive signals independently of each other, achieving a 4*4 multiple input multiple output (MIMO) operation mode for the MHB and the UHB. Each antenna assembly 100 is capable of supporting both LTE-4G and NR-5G signals, thus achieving dual connection for LTE-4G and NR-5G signals. Each antenna assembly 100 is capable of support multiple resonant modes, and bands supported by adjacent resonant modes can be combined into an ultra-wide bandwidth through carrier aggregation, thereby enhancing throughput, improving user experience, reducing adjustable components, and saving costs. In other words, the four antenna assemblies 100 may be distributed around the entire electronic device 1000, achieving 4*4 MIMO with multiple CA or ENDC combinations for the MHB and the UHB. The four antenna assemblies 100 may be distributed on four side frames of the whole electronic device 1000, thereby achieving detection on both approach of a human body to a rear face of the electronic device 1000 (i.e., a surface where the rear cover is positioned) and detection on approach of a human body to a front face of the electronic device 1000 (i.e., a surface where the display screen is positioned). This can achieve 360-degree coverage and accurate detection. In addition, the four antenna assemblies 100 are each integrated with a human body approach detection function, allowing intelligent switch among the four antenna assemblies 100, and in turn allowing the electronic device 1000 to intelligently adjust communication quality in various holding scenarios.

Optionally, in a case where the second antenna assembly 120, the third antenna assembly 130, and the fourth antenna assembly 140 do not support a band supported by the first antenna assembly 110, the controller 202 is configured to operate as follows. Upon determining that the electronic device 1000 is held by the left hand, the controller 202 is configured to improve the power of the third antenna assembly 130 that is shielded to compensate for a loss caused by shielding of the third antenna assembly 130. Upon determining that an object shielding the third antenna assembly 130 of the electronic device 1000 is removed, the controller 202 is configured to lower the power of the third antenna assembly 130 to an initial state. Similarly, upon determining that the electronic device 1000 is held by the right hand, or is held in the portrait mode by two hands, or is held in the landscape mode by two hands, the controller 202 is configured to improve the power of the corresponding antenna assembly 100 that is shielded. By intelligently detecting the holding state of the electronic device 1000 and dynamically adjusting the power of the antenna assembly 100 according to the holding state of the electronic device 1000, the communication quality of the electronic device 1000 can ensured.

In other embodiments, the controller 202 can also determine a state of the electronic device 1000 through a sensor such as a gyro sensor in the electronic device 1000, and then adjust the power of each antenna assembly 100 according to the state of the electronic device 1000. For example, upon determining that the electronic device 1000 is picked up according to a detection of a sensor such as a gyro sensor, the controller 202 is configured to improve the power of each antenna assembly 100. Upon determining that the electronic device 1000 is put down or in a stationary state according to a detection of a sensor such as a gyro sensor, the controller 202 is configured to lower the power of each antenna assembly 100, thereby saving energy and achieving intelligent adjustment of the antenna assembly 100.

According to the antenna assembly 100 provided in the disclosure, by setting the structure of the radiator 10 and the position of the ground point A, multiple resonant modes can be excited. The multiple resonant modes can achieve ultra-wideband coverage, thereby realizing EN-DC/CA performance across multiple bands. This can improve the download bandwidth, thereby improving the throughput download speed and the user experience. In the disclosure, mutual enhancement of the multiple modes generated by the antenna assembly 100 can be achieved, so that an ultra-wide bandwidth can be effectively covered and costs are saved, which is beneficial to satisfying the requirements of major network operators. The radiator 10 of the antenna assembly 100 may also serve as a sensing electrode for detecting approach of a human body, so that the antenna assembly 100 can support the ultra-wideband and detect approach of a human body. Thus, the power of the antenna assembly 100 can be reduced during approach of the human head, thereby reducing the specific absorption rate of electromagnetic wave signals radiated by the antenna assembly 100 in the human head. A high integration and multifunctionality of the antenna assembly 100 can be achieved, and an occupy space of the antenna assembly 100 can be reduced. The multiple antenna assemblies 100 are provided and arranged in the electronic device 1000, so that the multiple antenna assemblies 100 can detect approach of a human body at different positions, and the controller 202 can determine, according to detection results of the multiple antenna assemblies 100, a mode which the electronic device 1000 is currently in, such as, the left-hand holding mode, the right-hand holding mode, the two-hand holding portrait mode, the two-hand holding landscape mode, the carrying mode, and the head approaching mode, thereby realizing intelligent detection on the mode which the electronic device 1000 is currently in. The controller 202 can also intelligently switch the power of the antenna assembly 100 according to the mode of the electronic device 1000, thereby ensuring that the electronic device 1000 can maintain a good antenna transmission rate in various shielding states and intelligently reduce the specific absorption rate of electromagnetic wave signals radiated by the electronic device 1000.

The above are only some embodiments of the disclosure. It is noted that, a person skilled in the art may make further improvements and modifications without departing from the principle of the disclosure, and these improvements and modifications shall also belong to the scope of protection of the disclosure.

What is claimed is:

1. An antenna assembly comprising:
a radiator comprising a first sub-radiator and a second sub-radiator, wherein a coupling gap is defined between the first sub-radiator and the second sub-radiator; the first sub-radiator comprises a first coupling end and a first free end, and the first sub-radiator further comprises a feed point and a first ground point, wherein the feed point is positioned between the first free end and the first coupling end, and a distance between the first ground point and the first coupling end is greater than a distance between the feed point and the first coupling end; the second sub-radiator comprises a second coupling end, a second free end, and a second ground point positioned between the second coupling end and the second free end, wherein the coupling gap is between the second coupling end and the first coupling end, and both the first ground point and the second ground point are configured to be electrically connected to a reference ground; and
a signal source electrically coupled to the feed point.

2. The antenna assembly of claim 1, wherein the radiator is configured to support at least three resonant modes under excitation of the signal source.

3. The antenna assembly of claim 1, wherein the first ground point is positioned at the first free end.

4. The antenna assembly of claim 3, wherein the radiator is configured to support a first resonant mode, a second resonant mode, and a third resonant mode under excitation of the signal source.

5. The antenna assembly of claim 4, wherein:
a first resonant current in the first resonant mode is at least distributed between the first ground point and the first coupling end and between the second coupling end and the second ground point, wherein a direction in which the first resonant current flows between the first ground point and the first coupling end is the same as a direction in which the first resonant current flows between the second coupling end and the second ground point;
a second resonant current in the second resonant mode is distributed between the first ground point and the first coupling end and between the second coupling end and the second free end, wherein a direction in which the second resonant current flows between the first ground point and the first coupling end is opposite to a direction in which the second resonant current flows between the second coupling end and the second ground point, and a direction in which the second resonant current flows between the second ground point and the second free end is opposite to a direction in which the second resonant current flows between the second coupling end and the second ground point; and
a third resonant current in the third resonant mode is distributed between the first ground point and the first coupling end and between the second coupling end and the second free end, wherein a direction in which the third resonant current flows between the first ground point and the first coupling end is opposite to a direction in which the third resonant current flows between the second coupling end and the second ground point, and a direction in which the third resonant current flows between the second ground point and the second free end is the same as a direction in which the third resonant current flows between the second coupling end and the second ground point.

6. The antenna assembly of claim 4, wherein the first resonant mode is a (⅛˜¼) wavelength mode in which the first sub-radiator operates, the second resonant mode is a (⅛˜¼) wavelength mode in which part of the second sub-radiator between the second coupling end and the second ground point operates, and the third resonant mode is a ½ wavelength mode in which the second sub-radiator operates.

7. The antenna assembly of claim 6, wherein:
a first band is supported in the first resonant mode, a second band is supported in the second resonant mode, and a third band is supported in the third resonant mode, wherein the first band, the second band, and the third band are consecutive; or
two bands of the first band, the second band, and the third band are consecutive; or
the first band, the second band, and the third band are inconsecutive.

8. The antenna assembly of claim 1, wherein the first ground point is positioned between the first free end and the feed point.

9. The antenna assembly of claim 8, wherein the radiator is configured to support a fourth resonant mode, a fifth resonant mode, a sixth resonant mode, and a seventh resonant mode under excitation of the signal source.

10. The antenna assembly of claim 9, wherein:
a fourth resonant current in the fourth resonant mode is at least distributed between the first free end and the first coupling end, wherein a direction in which the fourth resonant current flows between the first free end and the first ground point is opposite to a direction in which the fourth resonant current flows between the first ground point and the first coupling end;
a fifth resonant current in the fifth resonant mode is at least distributed between the first free end and the first coupling end and between the second coupling end and the second ground point, wherein a direction in which the fifth resonant current flows between the first free end and the first ground point, a direction in which the fifth resonant current flows between the first ground point and the first coupling end, and a direction in which the fifth resonant current flows between the second coupling end and the second ground point are the same with one another;
a sixth resonant current in the sixth resonant mode is at least distributed between the first ground point and the first coupling end and between the second coupling end and the second free end, wherein a direction in which the sixth resonant current flows between the first ground point and the first coupling end is opposite to a direction in which the sixth resonant current flows between the second coupling end and the second ground point, a direction in which the sixth resonant current flows between the second ground point and the second free end is opposite to a direction in which the sixth resonant current flows between the second coupling end and the second ground point; and
a seventh resonant current in the seventh resonant mode is at least distributed between the first ground point and the first coupling end and between the second coupling end and the second free end, wherein a direction in which the seventh resonant current flows between the first ground point and the first coupling end is opposite to a direction in which the seventh resonant current flows between the second coupling end and the second ground point, and a direction in which the seventh resonant current flows between the second ground point and the second free end is the same as a direction in which the seventh resonant current flows between the second coupling end and the second ground point.

11. The antenna assembly of claim 9, wherein the fourth resonant mode is a (⅛˜¼) wavelength mode in which part of the first sub-radiator between the first ground point and the first coupling end operates, the fifth resonant mode is a ½ wavelength mode in which the first sub-radiator operates, and the sixth resonant mode is a (⅛˜¼) wavelength mode in which part of the second sub-radiator between the second coupling end and the second ground point operates, and the seventh resonant mode is a ½ wavelength mode in which the second sub-radiator operates.

12. The antenna assembly of claim 11, wherein a fourth band is supported in the fourth resonant mode, a fifth band is supported in the fifth resonant mode, a sixth band is supported in the sixth resonant mode, and a seventh band is supported in the seventh resonant mode, wherein
the fourth band, the fifth band, the sixth band, and the seventh band are consecutive; or
three bands of the fourth band, the fifth band, the sixth band, and the seventh band are consecutive; or
two bands of the fourth band, the fifth band, the sixth band, and the seventh band are consecutive; or
the fourth band, the fifth band, the sixth band, and the seventh band are inconsecutive.

13. The antenna assembly of claim 8, wherein a length of part of the radiator between the first ground point and the first free end is (¼˜¾) times a length of the first sub-radiator.

14. The antenna assembly of claim 9, wherein at least one of:
the antenna assembly further comprises a first matching circuit electrically connected between the feed point and the signal source, wherein the first matching circuit comprises a first sub-circuit, the first sub-circuit has one end electrically connected to the feed point and another end electrically connected to the reference ground, and the first sub-circuit is capacitive when the first sub-circuit operates in a band supported by the fourth resonant mode, a band supported by the fifth resonant mode, a band supported by the sixth resonant mode, and a band supported by the seventh resonant mode; or
the antenna assembly further comprises a second matching circuit, and the first sub-radiator further has a first frequency-tuning point positioned between the first free end and the first ground point, wherein the second matching circuit has one end connected to the first frequency-tuning point and another end electrically connected to the reference ground, and the second matching circuit is capacitive when the second matching circuit operates in the band supported by the fourth resonant mode and the band supported by the fifth resonant mode; or
the antenna assembly further comprises a third matching circuit and the second sub-radiator further has a second frequency-tuning point positioned between the second coupling end and the second ground point, wherein the third matching circuit has one end connected to the second frequency-tuning point and another end electrically connected to the reference ground, and the third matching circuit is capacitive when the third matching circuit operates in the band supported by the fifth resonant mode, the band supported by the sixth resonant mode, and the band supported by the seventh resonant mode; or
the antenna assembly further comprises a fourth matching circuit and the second sub-radiator further has a third frequency-tuning point positioned between the second ground point and the second free end, wherein the fourth matching circuit has one end connected to the third frequency-tuning point and anther end electrically connected to the reference ground, and the fourth matching circuit is capacitive when the fourth matching circuit operates in the band supported by the sixth resonant mode and the band supported by the seventh resonant mode.

15. The antenna assembly of claim 1, wherein a length of part of the radiator between the second ground point and the second free end is (¼˜¾) times a length of the second sub-radiator.

16. The antenna assembly of claim 1, further comprising a direct current block (DC-block) assembly, a filter assembly, and a detection assembly, wherein
wherein at least one of:
the DC-block assembly is electrically connected between the first sub-radiator and the signal source and between the first sub-radiator and the reference ground, and the filter assembly has one end electrically connected to one side of the DC-block assembly close to the first sub-radiator or electrically connected to the first sub-radiator; or
the DC-block assembly is electrically connected between the second sub-radiator and the reference ground, and the filter assembly has one end electrically connected to one side of the DC-block assembly close to the second sub-radiator or electrically connected to the second sub-radiator; and
the DC-block assembly is configured to block a direct current from the reference ground and a direct current generated by the signal source, the filter assembly is configured to block a radio frequency (RF) signal transmitted/received by the radiator and to allow an induction signal generated by the radiator in response to approach of a subject to-be-detected to pass through, and the detection assembly is electrically connected to another end of the filter assembly and configured to detect a magnitude of the induction signal.

17. An electronic device, comprising:
a housing, a reference ground, and at least one antenna assembly;
wherein each of the at least one antenna assembly comprises a radiator and a signal source, wherein:
a radiator comprises a first sub-radiator and a second sub-radiator, wherein a coupling gap is defined between the first sub-radiator and the second sub-radiator; the first sub-radiator comprises a first coupling end and a first free end, and the first sub-radiator further comprises a feed point and a first ground point, wherein the feed point is positioned between the first free end and the first coupling end, and a distance between the first ground point and the first coupling end is greater than a distance between the feed point and the first coupling end; the second sub-radiator comprises a second coupling end, a second free end, and a second ground point positioned between the second coupling end and the second free end, wherein the coupling gap is between the second coupling end and the first coupling end, and both the first ground point and the second ground point are configured to be electrically connected to the reference ground; and
a signal source is electrically coupled to the feed point; and
the reference ground is positioned in the housing, and a radiator of the at least one antenna assembly is attached to the housing, and the first ground point and the second ground point are both electrically connected to the reference ground.

18. The electronic device of claim 17, wherein the reference ground comprises a plurality of side edges connected in sequence, a joint between each two adjacent side edges is a corner, and wherein
the radiator of the at least one antenna assembly is disposed corresponding to two intersected side edges in the plurality of side edges and the corner between the two intersected side edges; or
the radiator of the at least one antenna assembly is disposed wholly corresponding to one of the plurality of side edges.

19. The electronic device of claim 17, wherein:
the at least one antenna assembly comprises a first antenna assembly and a second antenna assembly arranged diagonally, and the detection assembly is configured to detect both an induction signal generated by the first antenna assembly in response to approach of the subject to-be-detected and an induction signal generated by the second antenna assembly in response to approach of the subject to-be-detected; and
the electronic device further comprises a controller, wherein the controller is electrically connected to the first antenna assembly, the second antenna assembly, and the detection assembly, and the controller is configured to adjust a power of the first antenna assembly according to a magnitude of the induction signal generated by the first antenna assembly and to adjust a power of the second antenna assembly according to a magnitude of the induction signal generated by the second antenna assembly.

20. The electronic device of claim 19, wherein:
the at least one antenna assembly further comprises a third antenna assembly and a fourth antenna assembly, wherein at least part of the first antenna assembly, at least part of the second antenna assembly, at least part of the third antenna assembly, and at least part of the fourth antenna assembly are disposed at different sides of the reference ground, respectively, and the detection assembly is configured to detect an induction signal generated by the third antenna assembly and an induction signal generated by the fourth antenna assembly in response to approach of the subject to-be-detected; and
the controller is further electrically connected to the third antenna assembly and the fourth antenna assembly, wherein the controller is configured to determine a mode which the electronic device is currently in according to at least one of the magnitude of the induction signal generated by the first antenna assembly, the magnitude of the induction signal generated by the second antenna assembly, a magnitude of the induction signal generated by the third antenna assembly, and a magnitude of the induction signal generated by the fourth antenna assembly, and to adjust at least one of the power of the first antenna assembly, the power of the second antenna assembly, a power of the third antenna assembly, and a power of the fourth antenna assembly according to the mode, and the mode comprises at least one of a one-hand holding mode, a two-hand holding mode, a carrying mode, and a head approaching mode.
